(19) United States
(12) Patent Application Publication
(10) Pub. No.: US 2025/0150511 A1
(43) Pub. Date: May 8, 2025

(54) ARTICLE PROVISIONING

(71) Applicant: INTERNATIONAL BUSINESS MACHINES CORPORATION, ARMONK, NY (US)

(72) Inventors: Jennifer M. HATFIELD, Portland, OR (US); Sarbajit K. RAKSHIT, Kolkata (IN); Aaron K. BAUGHMAN, CARY, NC (US); Tushar AGRAWAL, West Fargo, ND (US); Vinod A. VALECHA, PUNE (IN)

(21) Appl. No.: 18/500,182

(22) Filed: Nov. 2, 2023

(51) Int. Cl. H04L 67/52; H04L 67/56

(52) U.S. Cl. CPC H04L 67/52; H04L 67/56

(57) ABSTRACT

Methods, computer program products, and systems are presented. The method computer program products, and systems can include, for instance: with a user engaged in a user session within a first environment, examining historical data of the user, wherein the examining historical data of the user includes examining historical data of a previously recognized article of the user previously recognized in a second environment; and provisioning an article of the user within the first environment to include a functional behavior.

### BACKGROUND

Embodiments herein relate to the virtual reality experience and more particularly to provisioning of user associated electronic device articles between physical world and virtual world.

A virtual world (VW) defining a virtual reality (VR) environment, also referred to as a metaverse, is a computer-based simulated environment. Many virtual worlds are represented using three-dimensional (3D) graphics and landscapes. The properties and elements of the virtual world often resemble the properties of the real world, such as in terms of physics, and 3D content such as houses, and landscapes. Virtual worlds may be populated by thousands of users simultaneously. In a virtual world, users are sometimes referred to as “residents” or “agents”.

The users in a virtual world can interact, inhabit, and traverse the virtual world through the use of avatars. An avatar is a graphical representation of a user that other users in the virtual world can see and interact with. The avatar's appearance is typically selected by the user and often takes the form of a cartoon-like representation of a human. However, avatars may also have non-human appearances, such as animals, elves, trolls, orcs, fairies, and other fantasy creatures.

A viewable field is the field of view for a particular user. The viewable field for a particular user may include objects, as well as avatars belonging to other users. An object is an element in a virtual world that does not represent a user. An object may be, for example, buildings, statues, billboards, signs, and advertisements in the virtual world. The viewable field of a particular user is determined by the virtual world software according to the geometries and textures that are currently loaded in a user's virtual world client. The virtual world software determines the length of time that a user views an object based on processing the data sent to each virtual world client.

Location based services (LBS) are software services that use location data to control functionality of computer systems LBS information services have a number of uses, e.g., in social networking, entertainment, security, and in a plurality of additional applications. LBS services employ location services for locating mobile computer systems. Location services can incorporate a variety of different locating service technologies such as the Global Positioning System (GPS), cellular network locating technologies, and WI-FI based locating technologies, and other technologies. One example of an LBS is a location based messaging services wherein notifications and other messages to users can be in dependence on the respective locations of the users.

Data structures have been employed for improving operation of computer system. A data structure refers to an organization of data in a computer environment for improved computer system operation. Data structure types include containers, lists, stacks, queues, tables, and graphs. Data structures have been employed for improved computer system operation e.g., in terms of algorithm efficiency, memory usage efficiency, maintainability, and reliability.

Artificial intelligence (AI) refers to intelligence exhibited by machines. Artificial intelligence (AI) research includes search and mathematical optimization, neural networks, and probability. Artificial intelligence (AI) solutions involve features derived from research in a variety of different science and technology disciplines ranging from computer science, mathematics, psychology, linguistics, statistics, and neuroscience. Machine learning has been described as the field of study that gives computers the ability to learn without being explicitly programmed.

### SUMMARY

Shortcomings of the prior art are overcome, and additional advantages are provided, through the provision, in one aspect, of a method. The method can include, for example: with a user engaged in a user session within a first environment, examining historical data of the user, wherein the examining historical data of the user includes examining historical data of a previously recognized article of the user previously recognized in a second environment; and provisioning an article of the user within the first environment to include a functional behavior, wherein the article of the user within the first environment includes an article type classification in common with the previously recognized article, and wherein the provisioning the article to include the functional behavior is performed in dependence on a result of the examining the historical data of the user.

In another aspect, a computer program product can be provided. The computer program product can include a computer readable storage medium readable by one or more processing circuit and storing instructions for execution by one or more processor for performing a method. The method can include, for example: with a user engaged in a user session within a first environment, examining historical data of the user, wherein the examining historical data of the user includes examining historical data of a previously recognized article of the user previously recognized in a second environment; and provisioning an article of the user within the first environment to include a functional behavior, wherein the article of the user within the first environment includes an article type classification in common with the previously recognized article, and wherein the provisioning the article to include the functional behavior is performed in dependence on a result of the examining the historical data of the user.

In a further aspect, a system can be provided. The system can include, for example a memory. In addition, the system can include one or more processor in communication with the memory. Further, the system can include program instructions executable by the one or more processor via the memory to perform a method. The method can include, for example: with a user engaged in a user session within a first environment, examining historical data of the user, wherein the examining historical data of the user includes examining historical data of a previously recognized article of the user previously recognized in a second environment; and provisioning an article of the user within the first environment to include a functional behavior, wherein the article of the user within the first environment includes an article type classification in common with the previously recognized article, and wherein the provisioning the article to include the functional behavior is performed in dependence on a result of the examining the historical data of the user.

Additional features are realized through the techniques set forth herein. Other embodiments and aspects, including but not limited to methods, computer program product and system, are described in detail herein and are considered a part of the claimed invention.

### BRIEF DESCRIPTION OF THE DRAWINGS

One or more aspects of the present invention are particularly pointed out and distinctly claimed as examples in the claims at the conclusion of the specification. The foregoing and other objects, features, and advantages of the invention are apparent from the following detailed description taken in conjunction with the accompanying drawings in which:

FIG. 1 depicts a system having a manager system, client computer devices, and a social media system according to one embodiment;

FIG. 2A-2C is a flowchart illustrating a method for performance by a manager system interoperating with UE devices and a social media system according to one embodiment;

FIG. 3A-3B depict a user interface in which generated prompting data is presented to a user in a virtual reality environment according to one embodiment;

FIG. 3C-3D depict a user interface in which generated prompting data is presented to a user in a physical environment according to one embodiment;

FIG. 4A depicts a machine learning model according to one embodiment;

FIG. 4B depicts a machine learning model according to one embodiment;

FIG. 4C depicts a machine learning model according to one embodiment;

FIG. 5A-5B depicts a machine learning model according to one embodiment;

FIG. 6A depicts a virtual reality rendering system according to one embodiment;

FIG. 6B is a block diagram depicting data flow between various hardware and software components of a client/server environment implementing a virtual world according to one embodiment;

FIG. 7 depicts a computing environment according to one embodiment.

### DETAILED DESCRIPTION

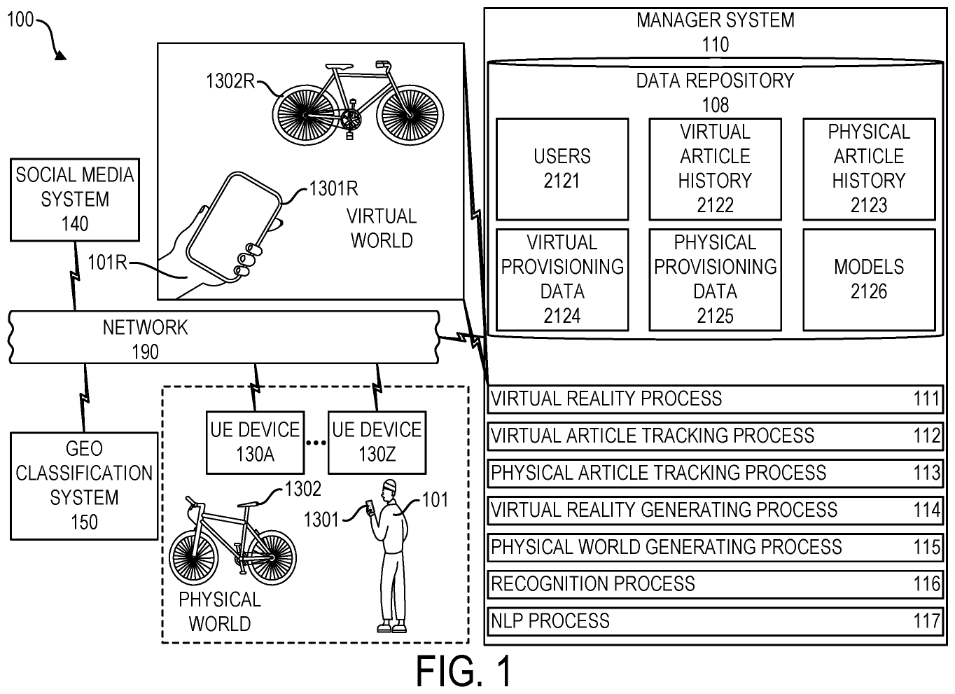

System 100 for use in provisioning articles including electronic device articles is shown in FIG. 1. System 100 can include manager system 110 having an associated data repository 108, user equipment (UE) devices 130A-130Z, and social media system 140. Manager system 110, UE devices 130A-130Z and social media system 140 can be in communication with one another via network 190. Network 190 can include a physical network and/or a virtual network. A physical network can include for example, a physical telecommunications network connecting numerous computing nodes or systems, such as computer servers and computer clients. A virtual network can, for example, combine numerous physical networks or parts thereof into a logical virtual network. In another example, numerous virtual networks can be defined over a single physical network. In the context of UE devices 130A-130Z, “Z” can refer to an integer of any arbitrary value.

Manager system 110, instances of UE devices 130A-130Z, and social media system 140 can be provided by computing node based systems, wherein each of manager system 110, instances of UE devices 130A-130Z and social media system 140 can include one or more computing node.

In one embodiment, manager system 110 can be external from each instance of UE devices 130A-130Z and social media system 140. In one embodiment, manager system 110 can be collocated with one or more instance of UE devices 130A-130Z and social media system 140.

UE devices 130A-130Z can include, e.g., smartphones, laptops, tablets, and the like. UE devices 130A-130Z can also or alternatively, e.g., Internet of things (IoT) devices, e.g., smart sensors, smart appliances, smart recreational equipment, and the like.

Social media system 140 can include a collection of files, including, for example, HTML files, CSS files, image files, and JavaScript files. Social media system 140 can be a social website such as FACEBOOK® (Facebook is a registered trademark of Facebook, Inc.), TWITTER® (Twitter is a registered trademark of Twitter, Inc.), LINKEDIN® (LinkedIn is a registered trademark of LinkedIn Corporation), or INSTAGRAM® (Instagram is a registered trademark of Instagram, LLC). Computer implemented social networks incorporate messaging systems that are capable of receiving and transmitting messages to client computers of participant users of the messaging systems. Messaging systems can also be incorporated in systems that have minimal or no social network attributes. A messaging system can be provided by a short message system (SMS) text message delivery service of a mobile phone cellular network provider, or an email delivery system. Manager system 110 can include a messaging system in one embodiment. During a process of registration wherein a user of system 100 registers as a registered user of system 100, a user sending registration data can send with permission data defining the registration data a permission that grants access by manager system 110 to data of the user within social media system 140. On being registered, manager system 110 can examine data of social media system 140, e.g., to determine whether first and second users are in communication with one another via a messaging system of social media system 140. A user can enter registration data using a user interface displayed on a client computer device of client computer devices 130A-130Z. Entered registration data can include, e.g., name, address, social media account information, other contact information, biographical information, background information, preferences information, and/or permissions data, e.g., can include permissions data allowing manager system 110 to query data of a social media account of a user provided by social media system 140 including messaging system data and any other data of the user. When a user opts-in to register into system 100 and grants system 100 permission to access data of social media system 140, system 100 can inform the user as to what data is collected and why, that any collected personal data may be encrypted, that the user can opt out at any time, and that if the user opts out, any personal data of the user is deleted.

Geoclassification system 150 can associate venues to spatial coordinate ranges associated to the venues. Geoclassification system 150 can include enhanced spatial maps pre-marked with tags to indicate uses associated with map features. Map features can include venues having associated venue areas including venue building areas and/or associated venue parking areas. An enhanced map can include tag specifying usage classifications of venues, e.g., residential, business, public and the like. An enhanced map can be tagged to tag features of a map including, e.g., roads, bodies of water and infrastructure features such as building walls (exterior and interior) defining enterprise venues. In some cases, an enhanced map can be tagged so that different parts of a building are tagged differently, e.g., a doorway can be tagged differently from a conference room. Geoclassification system 150 can provide data tags associated to locations that specify uses associated with various locations. Geoclassification system 150 can cognitively map venues identified by venue identifiers, e.g., names, addresses, classifications, and the like, to coordinate location ranges associated to the various venues. Accordingly, manager system 110 querying geoclassification system 150, with location data in the form of coordinate location data, can return an identifier venue. Further, geoclassification system 150 can cognitively map venues that are listed in geoclassification system with uses associated with such venues, e.g., whether such venues are for residential use, business use, public use and include a variety of additional or alternative use classifications, e.g., public use, roadway use, waterway use, and the like. An enhanced map can be tagged to tag features of a map, including e.g., roads, bodies of water and venues. Venues can be provided, e.g., by open spaces, such as developed open spaces or undeveloped open spaces, buildings such as open roof building or closed roof buildings, and/or open spaces associated to buildings, such as building associated with a parking lot. For each venue, geoclassification system 150 can associate, e.g., identifiers for the venue, ranges and coordinate locations associated with the venue, features associated to the venue, such as building infrastructure features, parking lot features, and other features. Geoclassification system 150 according to one embodiment can be provided by GOOGLE MAPS® (GOOGLE MAPS® is a registered trademark of Google, Inc.).

Embodiments herein facilitate transitioning between a physical world and a virtual world so that experiences of users in a physical world can be emulated in a virtual world and vice versa. Embodiments herein recognize that users with increasing frequency are transitioning between physical world environments and virtual world environments. Embodiments herein recognize that users can use commonly classified articles including electronic device articles when transitioning between physical world and virtual world environments. Embodiments herein facilitate provisioning virtual articles to include behavioral and functional attributes of their physical world counterparts and can facilitate provisioning of physical articles to include behavioral and functional attributes of their virtual world counterparts.

Data repository 108 in users area 2121 can store data on users of system 100. Users of system 100 can include registered users and guest users. In users area 2121, data repository 108 can record universal unique identifier (UUID) for each new registered user as well as additional information including, e.g., contact information, including social media address information and article identifiers of articles associated to each user.

The recorded articles can include article classifications, e.g., smartphone, tablet, smart bicycle, smartwatch, and the like can record whether the article is a physical world article, or virtual world article. Embodiments herein identify and record associations between real world articles and virtual articles of a user.

Data repository 108 in virtual article history area 2122 can store data on virtual articles encountered by a user. Manager system 110 can be configured so that when a virtual article is encountered in a virtual world, manager system 110 records data on an article event. The article event can specify, e.g., an article classification, article use classifier, an article provisioning functional behavior data action classifier specifying a provisioned functional behavior, an accompanying articles vector, an attendees classifier, and an environment classifier. The article classifier can specify type of article, e.g., smartphone, tablet, laptop, smart bicycle, smart appliance, and the like. The article usage classifier can specify the type of action being performed by the user with respect to the article during the detection event the data action classifier can specify the type of data transfer requested by the user during the detection event. The attendees classifier can specify type of attendees in the environment of the user during the detection event. The environment classifier can specify the type of environment, e.g., outdoors, in residence, in office, in article acquisition venue.

Data repository 108 in physical article history area 2123 can store data on events wherein a user encounters an article in a physical world. Manager system 110 can be configured so that when an article is encountered in a physical world environment, manager system 110 records data on an article event. The article event can specify, e.g., an article classification, article use classifier, an article functional behavior provisioning data action classifier, an accompanying articles vector, an attendees classifier and an environment classifier. The article classifier can specify type of article, e.g., smartphone, tablet, laptop, smart bicycle, smart appliance and the like. The article usage classifier can specify the type of action being performed by the user with respect to the article during the detection event, the functional behavior provisioning data action classifier can specify the type of provisioning functional behavior and data transfer requested by the user during the detection event. The attendees classifier can specify type of attendees in the environment of the user during the detection event. The environment classifier can specify the type of environment, e.g., outdoors, in residence, in office, in article acquisition venue.

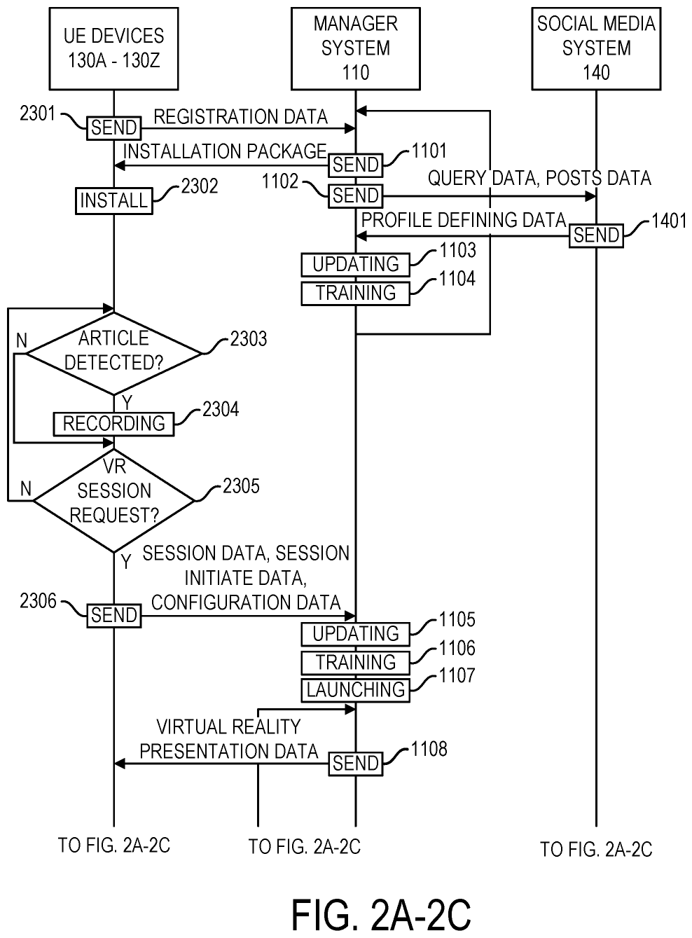

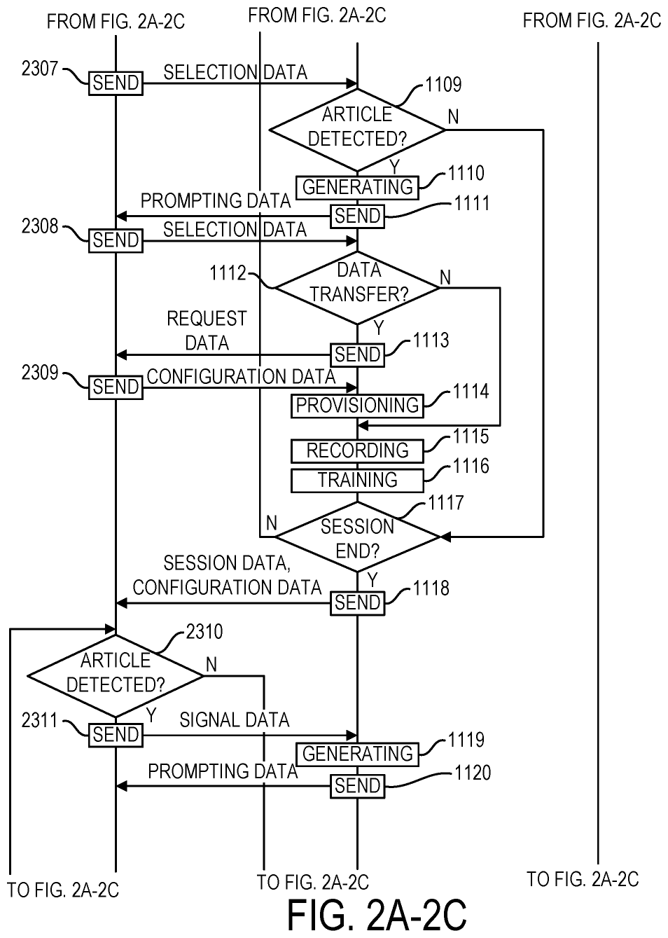

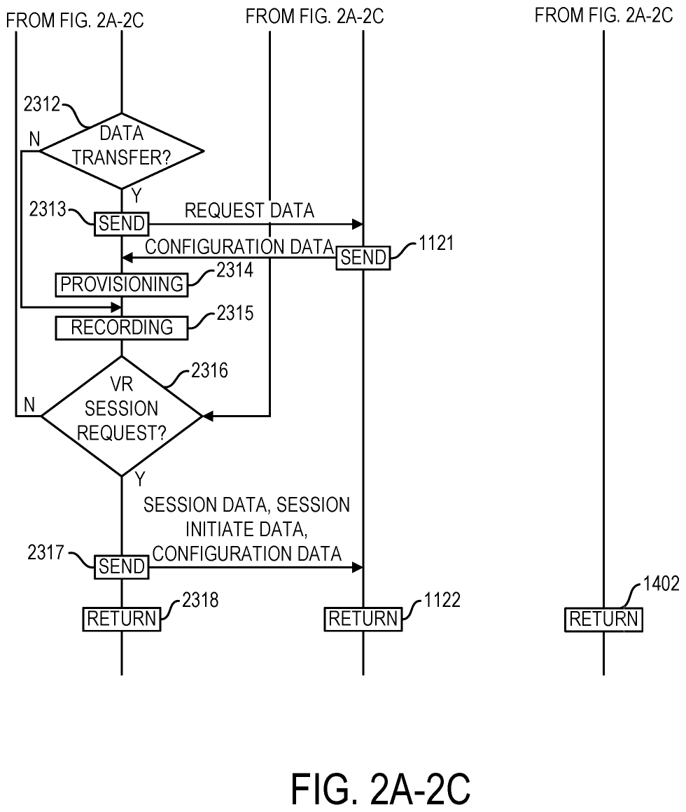

Data repository 108 in virtual provisioning data area 2124 can store data for use in provisioning virtual articles to include functional behavior of their counterpart physical articles. Provisioning data for use in provisioning of a certain virtual article can include, e.g., provisioning defining a functional behavior of a counterpart physical article of the certain virtual article. Provisioning data stored in virtual provisioning data area 2124 can include software code authored by a crowdsourced collection of crowdsourced users in response to physical article posts data sent to social media system 140 at block 1102 (FIGS. 2A-2C).

Data repository 108 in physical provisioning data area 2125 can store data for use in provisioning physical articles to include functional behavior of their counterpart virtual articles. Provisioning data for use in provisioning of a certain physical article can include, e.g., programming data defining a functional behavior of a counterpart virtual article of the certain physical article. Provisioning data stored in physical provisioning data area 2125 can include software code authored by a crowdsourced collection of crowdsourced users in response to virtual article posts data sent to social media system 140 at block 1102 (FIGS. 2A-2C).

Data repository 108 in models area 2126 can store data on predictive models that have been trained by machine learning training. An example of a machine learning predictive model can be a provisioning data predictive model which predicts the type of article provisioning which will be requested and performed by a user with respect to an article when encountered. Predictive models stored in machine learning models area 2126 can be trained with training data that includes training data obtained from virtual article history area 2122 and/or physical article history area 2123.

Manager system 110 can run various processes. Manager system 110 running virtual reality process 111 can include manager system 110 presenting to a user a 3D virtual world. Manager system 110 running virtual reality process 111 can include manager system 110 running a 3D engine.

Manager system 110 running virtual article tracking process 112 can include manager system 110 tracking virtual article detection events. Manager system 110 running virtual article tracking process 112 can include manager system 110 detecting for the presence of a virtual article during a virtual reality session in which the user participates. When a virtual article is detected, manager system 110 can record in virtual article history area 2122 various data, e.g., a classifier for the article, and other classifiers, including a usage classifier, functional behavior provisioning data action classifier specifying a functional behavior selected for provisioning, an attendees classifier, and environment classifier as set forth in reference to virtual articles history area 2122.

Manager system 110 running physical world article tracking process 113 can include manager system 110 detecting for the presence of a physical article during a physical world session in which the user participates. When a physical article is detected, manager system 110 can record in physical article history area 2122 various data, e.g., a classifier for the article, and other classifiers, including a usage classifier, functional behavior provisioning data action classifier specifying a functional behavior selected for provisioning, attendees classifier, and environment classifier as set forth in reference to virtual articles history area 2123. In some embodiments, tracking operations of physical article tracking process 113 can be performed by a UE device and manager system 110 performing article tracking process 113 can include manager system 110 receiving recorded article tracking data from the UE device.

Manager system 110 running virtual reality generating process 114 can include manager system 110 generating prompting data that prompts the user to initiate a provisioning data transfer for provisioning a virtual article. Manager system 110 running generating process 114 can include manager system 110 employing a multifactor decision process can include manager system 110 querying a predictive model that has been trained with use of training data.

Manager system 110 running physical article prompting data generating process 115 can include manager system 110 generating prompting data for prompting a user to perform transfer of provisioning data for provisioning a physical world article. Manager system 110 running generating process 114 can include manager system 110 employing a multifactor decision process can include manager system 110 querying a predictive model that has been trained with use of training data.

Manager system 110 running a virtual article provisioning process can include manager system 110 provisioning a virtual article of a user with provisioning data that causes a specified virtual world article to emulate to be the functional behavior of a commonly classified real (physical) world article of the user.

Manager system 110 running a physical world provisioning process can include manager system 110 provisioning a virtual article of a user with provisioning data that causes a specified virtual world article to emulate to be the functional behavior of a commonly classified real world article of the user.

In one embodiment, manager system 110 running recognition process 116 can include manager system 110 examining spatial image data representing a feature of interest. Manager system 110 running recognition process 116 can include manager system employing pattern recognition processing using one or more of, e.g., feature extraction algorithms, classification algorithms, and/or clustering algorithms. In one embodiment, manager system 110 running recognition process 114 can include performing of digital image processing. Digital image processing can include, e.g., filtering, edge detection, shape classification, optical character recognition (OCR), and/or encoded information decoding.

Manager system 110 running natural language processing (NLP) process 117 can include manager system 110 processing text based data for determining one or more NLP output parameter of a message. NLP process 117 can include one or more of a topic classification process that determines topics of messages and output one or more topic NLP output parameter, a sentiment analysis process which determines sentiment parameter for a message, e.g., polar sentiment NLP output parameters, “negative,” “positive,” and/or non-polar NLP output sentiment parameters, e.g., “anger,” “disgust,” “fear,” “joy,” and/or “sadness” or other classification process for output of one or more other NLP output parameters, e.g., one of more “social tendency” NLP output parameter or one or more “writing style” NLP output parameter.

By running of NLP process 117 manager system 110 can perform a number of processes including one or more of (a) topic classification and output of one or more topic NLP output parameter for a received message (b) sentiment classification and output of one or more sentiment NLP output parameter for a received message or (c) other NLP classifications and output of one or more other NLP output parameter for the received message.

Topic analysis for topic classification and output of NLP output parameters can include topic segmentation to identify several topics within a message. Topic analysis can apply a variety of technologies, e.g., one or more of Hidden Markov model (HMM), artificial chains, passage similarities using word co-occurrence, topic modeling, or clustering. Sentiment analysis for sentiment classification and output of one or more sentiment NLP parameter can determine the attitude of a speaker or a writer with respect to some topic or the overall contextual polarity of a document. The attitude may be the author's judgment or evaluation, affective state (the emotional state of the author when writing), or the intended emotional communication (emotional effect the author wishes to have on the reader). In one embodiment sentiment analysis can classify the polarity of a given text as to whether an expressed opinion is positive, negative, or neutral. Advanced sentiment classification can classify beyond a polarity of a given text. Advanced sentiment classification can classify emotional states as sentiment classifications. Sentiment classifications can include the classification of “anger,” “disgust,” “fear,” “joy,” and “sadness.”

Manager system 110 running NLP process 117 can include manager system 110 returning NLP output parameters in addition to those specifying topic and sentiment, e.g., can provide sentence segmentation tags, and part of speech tags. Manager system 110 can use sentence segmentation parameters to determine, e.g., that an action topic and an entity topic are referenced in a common sentence for example.

A method for performance by manager system 110 interoperating with UE devices 130A-130Z and social media system 140 is set forth in reference to the flowchart of FIGS. 2A and 2B. At block 2301, UE devices of UE devices 130A-130Z associated to respective users can be sending registration data for receipt by manager system 110.

The registration data sent at block 2301 can include, e.g., name, contact information data, as well as permissions data of various users of system 100 and manager system 110. Permissions data can include permissions to use personal information data of the various users including personal data stored on UE devices 130A-130Z, personal data associated to virtual reality environments of the various users and personal data stored on social media system 140. On receipt of the registration data, manager system 110 can perform updating of update users data in users area 2121 and can proceed to send block 1101.

The registration data sent at block 2301 can include lists of articles associated to a user who is registering into system 100 and manager system 110. The lists of articles can specify articles that are associated to the current user and can include such articles as smartphone, IOT bicycle, smart appliance, and the like. On registering articles, manager system 110 can prompt a current user to specify identifying data for such articles. The identifying data can include, e.g., MAC addresses, serial numbers, operating systems versions, software versions and the like. Manager system 110 can later use such registration data for identification of a virtual article that corresponds to a physical article and vice versa. The registrations session can include processes in which a user is prompted to connect articles being registered to an interface of manager system 110, e.g., wireless or wireless to permit manager system to read identifying data of articles being registered.

At send block 1101, manager system 110 can send an installation package for receipt by users of UE devices 130A-130Z. In various embodiments herein, the respective user of manager system 110 and system 100 can communicate with manager system 110 via a mobile device of the user, e.g., a mobile smartphone and such mobile smartphone can be configured to communicate with other UE devices defining articles of the user, e.g., IoT UE devices of a user, such as smart sports equipment, e.g., smart bicycles, smart appliances, smart sensors, and the like.

At send block 1101, manager system 110 can send to UE devices of UE devices 130A-130Z installation packages. An installation package can include, e.g., libraries and executable code to facilitate participation of a UE device within system 100. On receipt of an installation package UE devices of UE devices 130A-130Z can perform installation of the installation package at install block 2301. In one example, an installation package can include an installation package for installing on a smartphone of a user that prefigures the smartphone to record activities in relation to other articles associated to a user. For example, an installation package installed on a smartphone of a user, e.g., UE device 1301 defining a UE device of UE devices 130A-130Z can configure the smartphone to detect IoT articles associated to a user, e.g., the bicycle IoT article provided by UE device 1301 of FIG. 1 defining another UE device of UE devices 130A-130Z depicted in FIG. 1, and to record activities of a user in relation to the IoT article for reporting to manager system 110. The installation package sent at block 1101 can include, e.g., features so that the UE device can perform recognition as explained in reference to recognition process 116.

On completion of send block 1101, manager system 110 can proceed to send block 1102. At query block 1102, manager system 110 can query social media system 140 for receipt of text based content of each newly registered user registered on receipt of registration data sent at block 2301. The text based content can include a messaging content and social media posts content of newly registered users. On receipt of the query data, social media system 140 at send block 1401 can send profile defining data regarding the registered users to manager system 110.

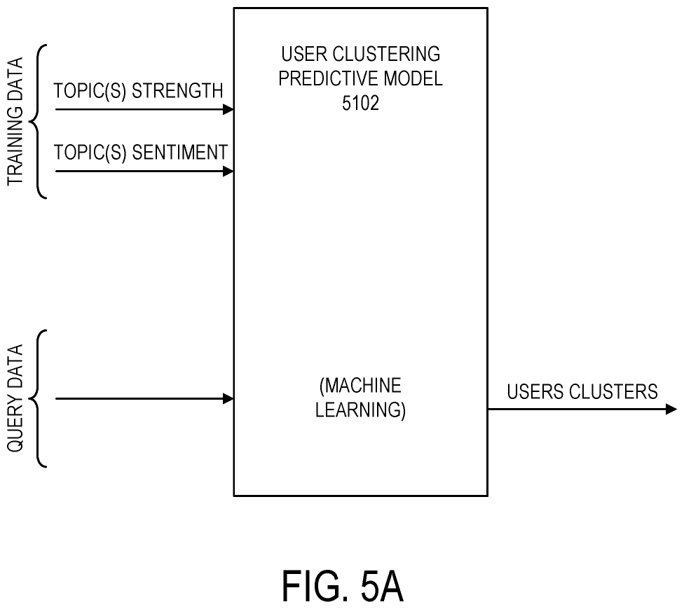

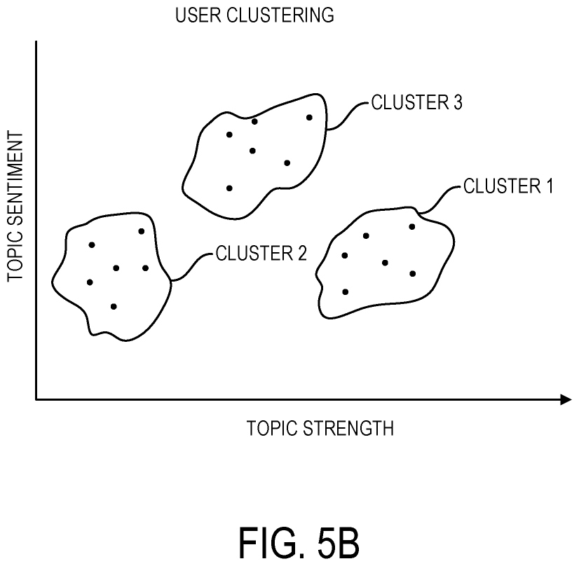

On receipt of the profile defining data sent at block 1401, manager system 110 can update user profiles of the various users in dependence on the received profile defining data and can store such updated profile data into users area 2121 of data repository 108. On receipt of the profile defining data sent by social media system 140 at send block 1401, manager system 110 can perform processing of the received profile defining data. The processing can include subjecting text based content of the various users to natural language processing to extract data on topics of interest to the various users as well as sentiment associated to such topics and at updating block 1103 can store such topic preferences and associated sentiments in respect to such topics in users area 2121 of data repository 108 associated to the various users subject to registration in response to receipt of registration data sent at send block 2301. On completion of updating at block 1103, manager system 110 can proceed to training block 1104. At training block 1104 manager system 110 can apply a next iteration of training data defined by the updated topic and sentiment profile data updated at block 1103 to clustering machine learning model 5102 described further herein in relation to FIGS. 5A and 5B. Manager system 110 can then loop back to iteratively perform the loop of blocks 1101-1104 while simultaneously branching to iteratively perform the loop of blocks 1105-1122 described further herein.

Manager system 110 in another aspect at send block 1102 can send posts data to establish a crowdsourced development session in which a crowdsourced collection of users can assist in generating provisioning data for provisioning virtual articles and physical articles. In one example, posts data sent at send block 1102 can specify newly registered articles specified in a most recent iteration of registration data sent at block 2301. In response to the registration data, manager system 110 can crawl various data sources for documentation in relation to the user articles being registered and manager system 110 can subject the returned documentation in the original registration data using natural language processing for identification of topics in relation to the articles newly registered, which topics can be observed by developer users for purposes of breaking down overall functioning of an article into discrete functional behaviors. The posts data sent at block 1102 can invite a crowdsourced collection of users to break down each registered article into constituent functional behaviors, e.g., for a smartphone, picture taking, browsing, active calendar, and the like. A finalized breakdown of functional behaviors can be derived via voting by the crowdsourced collection of users.

The posts data can further invite the development of crowdsourced software code defining provisioning data for emulation of discrete functional behaviors of the registered articles. Crowdsourced collection of developer users can input their coding solutions to social media system 140 which can be sent by social media system 140 to manager system 110, with the profile defining data at send block 1401. The posts data sent at block 1102 specifying information of registered articles can also specify identifiers of virtual reality platforms supported by manager system 110 and the crowdsourced collection of developer users can consult such information, as well as documentation of the various physical article set with the posts data sent at block 1102. At send block 1401, social media system 140 can send software code defining provisioning data for receipt by manager system 110. The virtual reality provisioning data can be sent by social media system 140 at send block 1401 for storage into virtual provisioning data area 2124 of data repository 108.

Also, at send block 1102, manager system 110 can send posts data that specifies virtual articles that have been specified in virtual article history area 2122 in a latest virtual reality session. Posts data can include documentation of such virtual articles collected via further web crawling by manager system 110 and can include video widgets demonstrating functional behavior of such virtual articles. The virtual world article posts data can commission crowdsourced tasks such as sectorizing operations of the virtual articles into discrete functional behaviors. In another aspect, the virtual article posts data can commission crowdsourced development tasks that tasks a crowdsourced developer users to author software code so that behaviors of the virtual articles are emulated in a counterpart physical world article. The additional physical world article provisioning data can be sent by social media system 140 at send block 1401 for storage into physical provisioning data area 2125 of data repository 108.

Upon completion of install block 2302, a UE device subject to installation can proceed to block 2303. At block 2303 a UE device of a user, e.g., UE device 1301 can detect, e.g., article 1301, a smart phone, and article 1302, a smart IoT bicycle in the environment of a user. Referring to FIG. 1 article 1301 and article 1302 can define UE devices of UE devices 130A-130Z. UE device 1301 and UE device 1302 can be provided by smartphone and smart bicycle IoT device respectively.

On the detection of an article at block 2302, UE device 1301 can proceed to recording block 2304. At recording block 2304, UE device 1301 can perform recording of data in respect to the detection event at block 2303. Recorded data recorded at block 2304 can include, e.g., classifier for the one or more article detected, usage classifier, a functional behavior provisioning data action classifier for the one or more detected article, an attendees classifier, and/or an environment classifier. Examples of article classifiers can include, e.g., smartphone, smart bicycle as depicted in FIG. 1, smart appliance tablet, visual inspection equipment and the like.

Usage classifiers for a smartphone can include, e.g., browsing, picture taking, telephone call, texting, social media use, and the like. Usage classifiers for a smart bicycle can include, e.g., riding, transporting, and fixing. Usage classifiers for a smartwatch can include, e.g., training and planning.

On completion of recording block 2304, UE device 1301 can proceed to block 2305. At block 2305, UE device 1301 can ascertain whether the user has specified a virtual reality session request. Where a user has not requested a virtual reality session request, UE device 1301 can iteratively perform the loop of blocks 2303-2305 recording data for articles detected until a time that a VR session request is detected at block 2305. Recorded article classification data recorded at block 2304 can include a session stamp specifying the physical world session in which the detection occurred and a time stamp for the article detecting. It will be seen that a same article can be detected iteratively at iterations of block 2303.

On the detection of a VR session request, UE device 1301 can proceed to send block 2306. At send block 2306, UE device 1301 defining a UE device of UE devices 130A-130Z can send data for receipt by manager system 110. The sent data can include session data of the just exited physical environment session of the user, session initiate data for initiating a new virtual reality session, and configuration data for use in provisioning a virtual world article (virtual article).

Regarding the described physical world session data, the physical world session data can include the recorded data recorded at block 2304 in respect to article detection events in the various data associated to those events as described in reference to block 2304. The session initiate data referred to in reference to block 2306 can include initiation data for initiating a new virtual reality session. The configuration data referred to in block 2306 can include configuration data that defines the functionality of one or more physical article as detected by UE device 1301 in the just exited physical world environment session. The described configuration data can include any data that defines a functional behavioral aspect of a physical article. A functional behavioral attribute can refer to an attribute herein other than an appearance attribute such as mere color or shape attribute.

Functional attributes of a smartphone, e.g., can include such functional attributes as browsing behavior usage, contact list maintaining usage, camera usage, phone usage, text messaging usage, and the like. Contact list usage can include, e.g., active contact list user interface functionality that permits text, phone, or email initiation via actuation of a user interface button.

On receipt of the session data session initiate data in provisioning data sent at block 2306, manager system 110 can perform updating at block 1105. Updating at block 1105 by manager system 110 can include updating physical article history area 2123 of data repository 108 to include the recorded article associated data recorded at recording block 2306 during a just completed physical world session of a user.

On completion of updating at block 1105, manager system 110 can proceed to training block 1106 and then to launching block 1107. At training block 1106, manager system 110 can perform training of machine learning models herein, such as predictive model 4102, predictive model 4202, predictive model 4302, and predictive model 5102 based on most recently obtained training data. At launching block 1107, manager system 110 can launch a new virtual reality session. With a virtual reality session initiated a user such as user 101 is instantiated in a virtual world as depicted in FIG. 1 and represented virtual world as represented entity 101R as shown in FIG. 1. On completion of updating at block 1103, manager system 110 can proceed to training block 1106. At training block 1106, manager system 110 can apply a next iteration of training data to train predictive model 4102 based on the recording session article data for the just completed physical world session as well as other predictive models herein based on most recently obtained training data. On completion of training block 1106, manager system 110 can proceed to launching block 1107. At launching block 1107, manager system 110 can launch a new virtual reality session. With a virtual reality session initiated, a user such as user 101 is instantiated in a virtual world as depicted in FIG. 1 and represented virtual world as represented entity 101R as shown in FIG. 1.

On launching of a virtual reality session at block 1107, manager system 110 can proceed to block 1108. At block 1108, manager system 110 can send virtual reality presentation data for receipt by one or more UE device, e.g., the UE device 1301 described in the reference example. On receipt of the virtual reality presentation data the user, e.g., user 101 in the described example can take action in the virtual world, e.g., by pressing user interface buttons of a UE device 1301 provided by smartphone to define selection data. The selection data sent at block 2307 can specify action, e.g., movement of use the user in a virtual reality world through different environments in a virtual reality world, wherein the user by moving within the virtual reality world may encounter new articles.

On completion of send block 1108, manager system 110 can proceed to block 1109. At block 1109, manager system 110 can ascertain whether a virtual article has been detected in the environment of the current user in the virtual world during the current virtual reality session. On the determination that a virtual article has been detected, manager system 110 can proceed to generating block 1110. At generating block 1110, manager system 110 can generate prompting data that prompts the user to provision a detected virtual world article with provisioning data that configures a functional behavior of the detected virtual world article. In generating of prompting data at generating block 1110, manager system 110 can apply scoring formula A as follows.

$$SV = FV 1 W 1 + FV 2 W 2 + FV 3 W 3 + FV 4 W 4 + FV 5 W 5 + FV 6 W 6 ( scoring formula A )$$

Where SV is a scoring value for scoring the current user's interaction with the article in the current virtual reality session, FV1 is a first factor, FV2 is a second factor, FV3 is a third factor, FV4 is a fourth factor, FV5 is a fifth factor, FV6 is a sixth factor and W1-W6 are weights associated to the various factors.

In one embodiment, FV1 can be a recency factor, FV2 can be a frequency factor, FV3 can be a predictive model factor, FV4 can be a provisioning factor, FV5 can be a security factor, and FV6 can be a tournament scoring factor. Manager system 110 applying scoring values under factor FV1 can assign scoring values under factor FV1 define scoring values in dependency on a recency which the user last interacted with a counterpart of the detected virtual article in a real-world physical world session.

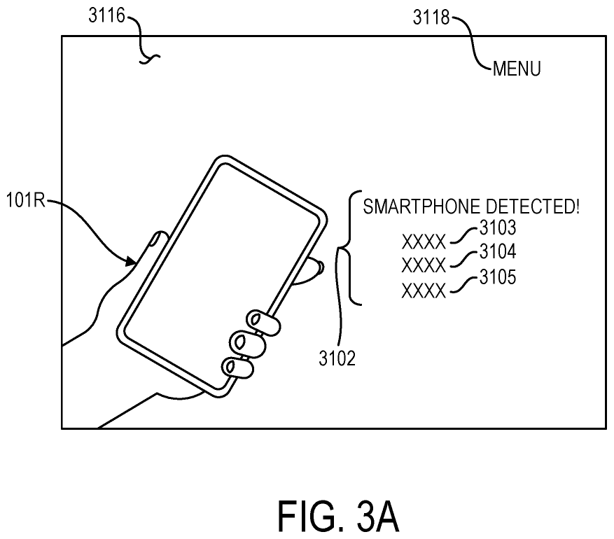

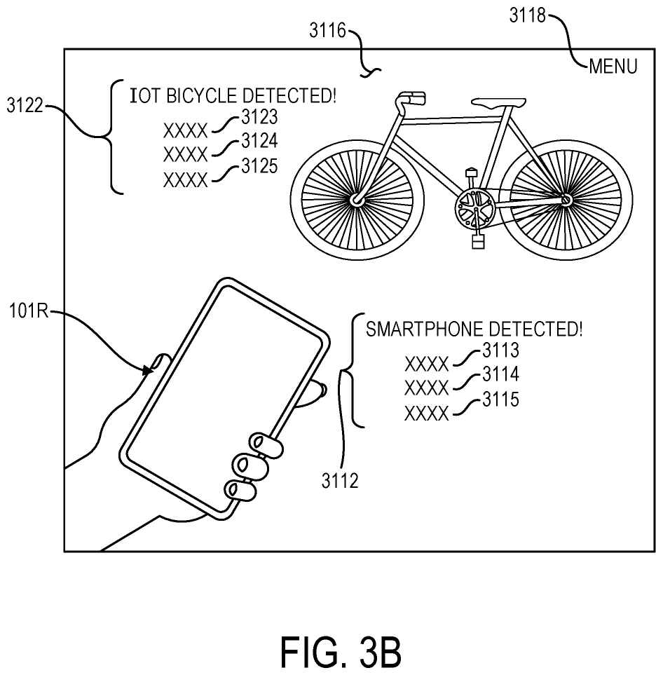

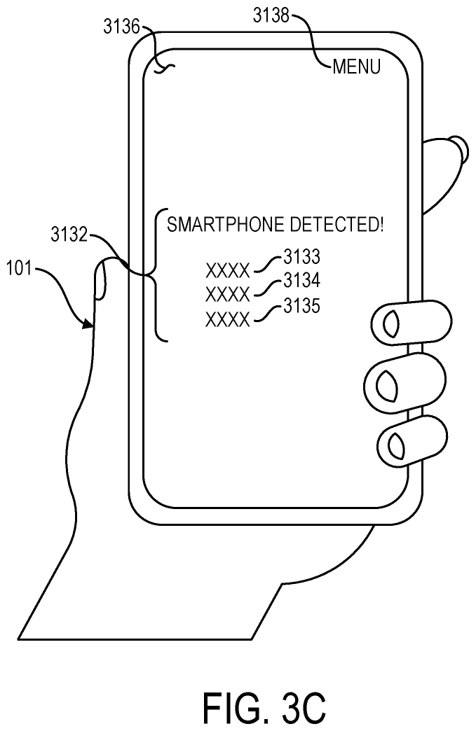

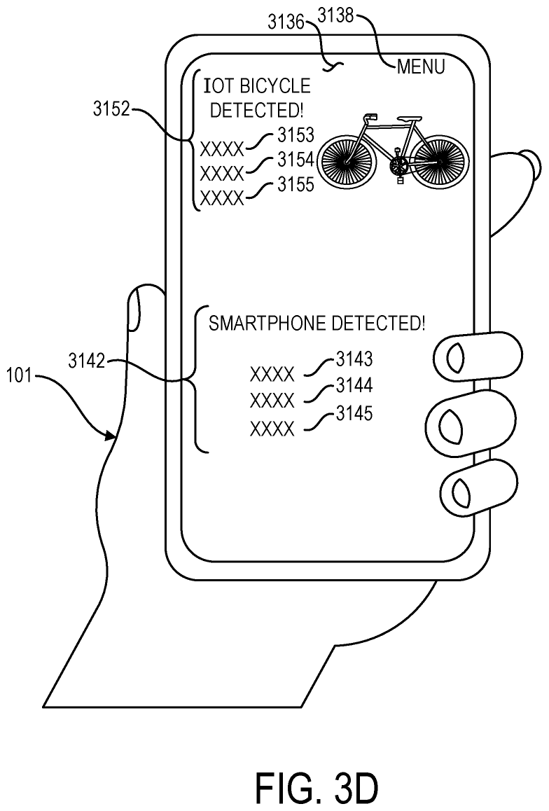

FIG. 3A depicts commencement of a virtual reality session corresponding to the session depicted on a high level in FIG. 1. At the commencement of a virtual reality session the user 101 (FIG. 1) in the described example represented as represented user 1301R in the virtual session can be holding a smartphone UE device corresponding to smartphone UE device 1301 shown in FIG. 1. The view main screen 3116 depicted in FIG. 3A can be a view presented in 3D in a VR headset or another UE device, e.g., smartphone, laptop, tablet, etc.

On detection of the virtual world smartphone depicted as 1301R in FIG. 3A, manager system 110 can perform generating of prompting data 3102 prompting the user to perform functional provisioning of the depicted smartphone article. In assigning scoring values under factor FV1, the recency factor, manager system 110 can ascertain a last time that a user encountered physical world article corresponding to the depicted article 1301R in a physical world session. On such determining, manager system 110 can ascertain that at the last physical world session terminated at block 2305 the user encountered UE device 1301 provided by a smartphone depicted in FIG. 1 can scale a scoring value assigned under factor FV1 according to the time lag between the time of the detection of the depicted article 1301 during the last physical world session of the user and the current time of detection of the virtual article detected at block 1109.

With further reference to scoring formula A, manager system 110 at generating block 1110 can scale scoring values under frequency factor FV2 in dependence on a frequency with which a physical world article corresponding to the detected article was detected in prior physical world sessions of the user. For example, where a detected virtual world article is a smartphone that was detected during 100 percent of cumulative (over multiple sessions) prior physical world session time of the user, manager system 110 can assign a scoring value of 1.0 (maximum) under frequency factor FV2. Where a detected virtual world article is an IoT bicycle that was detected during 5 percent of cumulative (over multiple sessions) prior physical world session time of the user, manager system 110 can assign a scoring value of 0.05 under frequency factor FV2.

With further reference to scoring formula A, manager system 110 at generating block 1110 can assign scoring values under factor FV3 in dependence on historical provisioning by the user of the virtual article detected at block 1109 and any physical counterpart of the virtual article in an historical physical world session of the user. Manager system 110 at generating block 1110 can scale scoring values under factor FV3 according to the cumulative bytes of historical provisioning data transferred to a virtual reality data engine for provisioning a functional behavior attribute of the detected article and/or counterpart physical world article of the currently detected virtual world article for provisioning a functional behavior attribute of the counterpart physical world article.

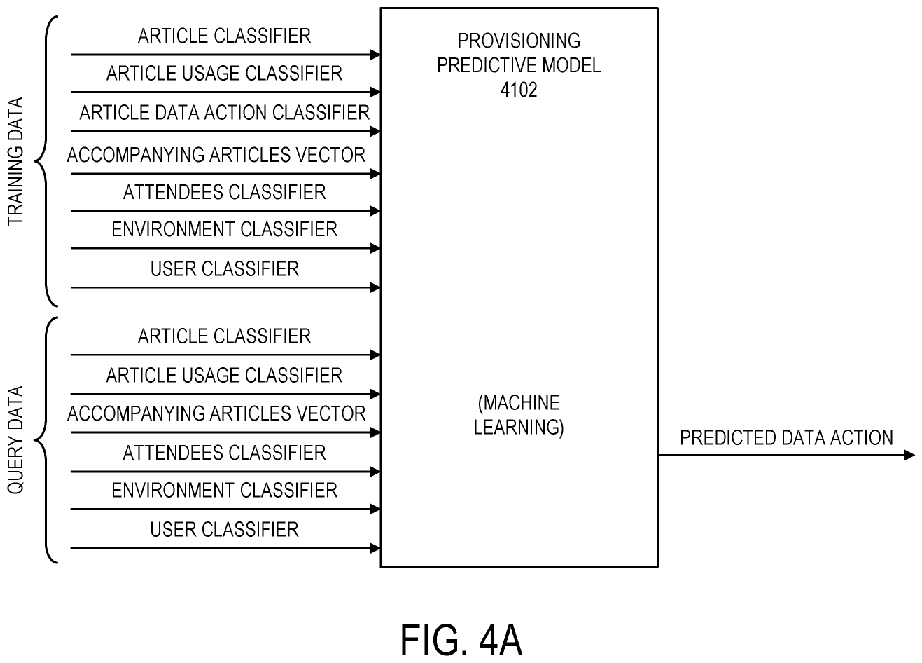

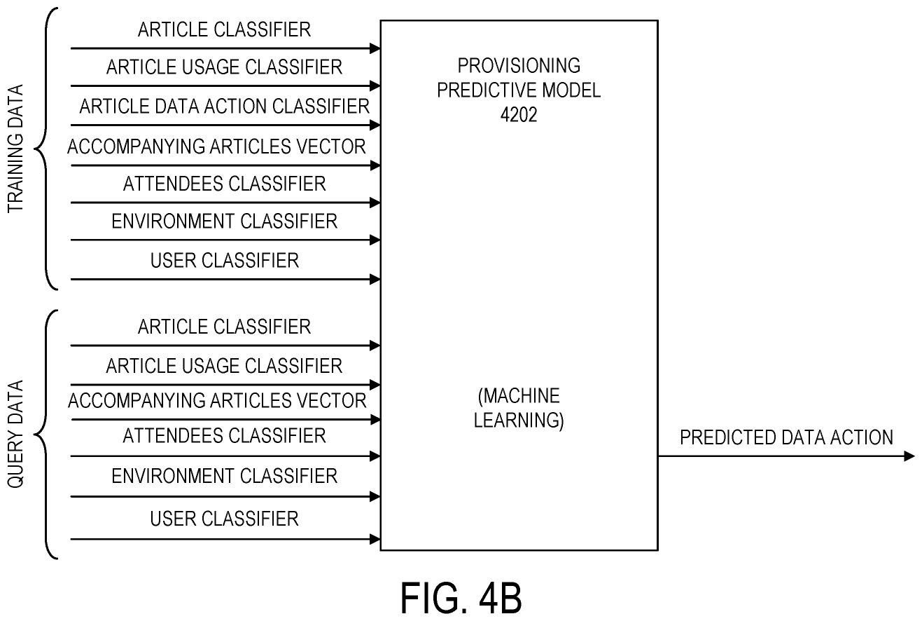

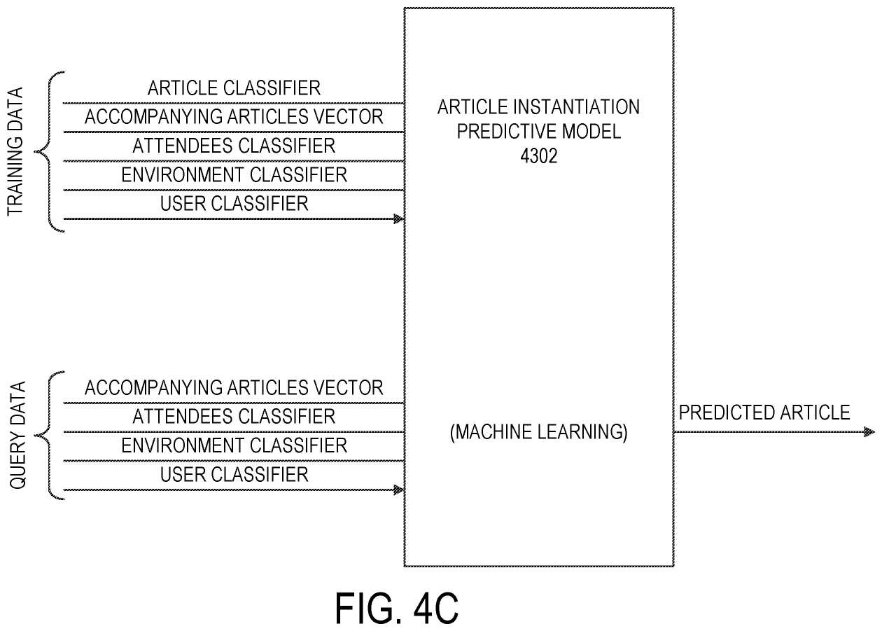

With further reference to scoring formula A, manager system 110 at generating block 1110 can assign scoring values under factor FV4 in dependence on an output resulting from query of provisioning data predictive model 4102 as shown in FIG. 4A. Provisioning data predictive model 4102 can predict a functional behavior provisioning data action of a user specifying a functional behavior for provisioning with respect to a detected virtual world article. Provisioning data predictive model 4102 can be trained with historical session data associated to a current user as well as a crowdsourced collection of other users of system 100 and manager system 110. Provisioning data predictive model 4102 can be trained with historical data of historical virtual reality sessions of a current user as well as a crowdsourced collection of all other users of system 100 and manager system 110. Provisioning data predictive model 4102 can be trained with training data and once trained can be responsive to query data for return of predictions as to what actions a user will take with respective provisioning a detected virtual world article.

Predictive model 4102 can be trained with iterations of training data, wherein each iteration comprises (a) an article classifier of a certain article detected in a certain historical virtual reality session in which a user was prompted to provision the certain article; (b) an article usage classifier that specifies one or more usage classification of a user with respect to the article in the certain historical virtual reality session; (c) an article data action classifier that specifies one or more functional behavior provisioning action of the user with respect to the article in the certain historical virtual reality session; (d) an accompanying articles vector that specifies identifiers for other articles in the environment of certain article during the certain historical virtual reality session; (e) an attendees classifier that specifies a classification of attendees accompanying the user during detecting of the article during the historical virtual reality session; (f) an environmental classifier for the environment encountered by the user during the detecting of the article during the historical virtual reality session; and (g) a user classifier that specifies the classification of user encountering the article detected during the historical virtual reality session. The described training can be performed for multiple, e.g., tens, thousands, millions of virtual reality sessions in which an article was detected and encountered by the current user and/or crowdsourced collection of other users. Embodiments herein recognized that by training predictive model 4102 with training data that specifies characteristics associated to past virtual article provisioning events, predictive model 4102 is able to learn trends influencing user action in terms of provisioning a virtual article.

The article classifier for training predictive model 4102 can be a classifier for an article during an historical virtual reality session in which a user was prompted for prompting, e.g., smartphone as described with reference in the example of FIG. 3A. The article usage classifier for training predictive model 4102 can refer to the usage of the detected article during the virtual reality session, e.g., holding, browsing, telephone calling, texting, and the like. The article provisioning data action classifier for training predictive model 4102 can refer to the functional behavior provisioning of the historical article by historical user and in an historical session mediated by manager system 110. The accompanying articles vector for training predictive model 4102 can specify identifiers for other articles in an environment of the article, the attendees classifier can classify for attendees in the environment of the virtual user during an historical virtual reality session. Possible attendees classifiers can be, e.g., no other attendees, one other attendee friend, one other attendee stranger, multiple other attendees friends, multiple other attendees strangers, and so on. Environmental classifiers can include, e.g., outside, residence, work environment, article acquisition venue and the like. The user classifier for training provisioning data predictive model 4102 can be based on clustering analysis, wherein manager system 110 identifies clusters of similar users based on preferences of such users of system 100 and manager system 110.

Clustering analysis for use in determining similar users is set forth in reference to FIGS. 5A-5B.

The user classifier for training predictive model 4102 set forth in FIG. 2 can refer to a type classification of a given user. Manager system 110 can establish a user classification for any user of system 100 by application of clustering analysis as set forth in FIGS. 5A-5B, wherein identified user clusters define user classifications.

Over time, manager system 110 can be iteratively updating clustering analysis for clustering and classifying users as set forth in FIG. 5A-5B. For performing clustering analysis illustrated in FIGS. 5A-5B for identification of common types of users, manager system 110 can be digesting text based documents associated to all users. The text based assets can include, e.g., social media posts of the various users as acquired from social media system 140 as well as other text based assets of the various users including text based assets acquired via acquisition of registration data sent at block 2301 and any text based article reviews posted by users acquired from social media system 140 as indicated by send block 1102, and any text based assets of a user input registration data sent at block 2301. In one use case, registration data defining text based assets of a user can include survey response data. Manager system 110 can be subjecting all text based assets of all users to natural language processing by operation of NLP process 117 for extraction of a topic strength of one or more key topic as well as sentiments associated to such topics.

FIG. 5A depicts a clustering machine learning model 5102 and FIG. 5B depicts functioning of the machine learning model. FIG. 5B depicts plotted dimensional data points for multiple users of system 100 for a designated key topic. For the key topic, manager system 110 can assign a topic strength value and a topic sentiment value. Manager system 110 can apply topic strengths as indicated in FIG. 5B in dependence on account of times the key topic is extracted per predetermined volume of asset data, e.g., based on a count of topic extractions for every 1000 words. Manager system 110 can apply a topic sentiment by performance of sentiment extraction using natural language processing on text based content associated to respective key topic extractions. Manager system 110 can identify clusters of users by their close proximity in Euclidean space, and can assign the clusters various cluster identifiers, e.g., cluster 1, cluster 2, and cluster 3 as depicted in FIG. 5B. Referring to FIG. 5B, manager system 110 can assign sentiment values to users for the key topic depicted on a scale, e.g., of 0.0 to 1.0 with values from 0.0 to 0.5 being negative sentiment values, the value of 0.5 being a neutral sentiment and the values 0.5 to 1.0 being positive sentiment values. While a single key topic is depicted in FIG. 5B, manager system 110 can expand the clustering analysis across additional dimensions defined by additional key topics.

Predictive model 4102, once trained, can be capable of returning predictions. For example, with reference to FIG. 4A, provisioning data predictive model 4102 can be queried with query data that specifies an article classifier, an article usage classifier, an accompanying articles vector, an attendees classifier, an environmental classifier, and a user classifier for the current virtual reality session for which prompting data is generated at block 1110. In response to the query data, provisioning data predictive model 4102 can generate a predicted provisioning action of a user, e.g., whether the user based on historical sessions of other users in the current user will provision a virtual current article, e.g., smartphone to assume new behavior, e.g., new functional behavior, e.g., contact list functionality, e.g., with auto contacting phone functionality, texting functionality, browsing functionality, picture taking functionality, and the like. Trained as described, provisioning predictive model 4102 is able to predict provisioning actions of a user.

Manager system 110 provisioning data predictive model 4102 in generating predicted provisioning data action decisions can assign confidence levels associated to the various predictions. The confidence level, in one example, can be dependent on trends exhibited by the training data and a volume of training data supporting certain prediction.

Manager system 110 can scale scoring values under factor FV4 (predictive model factor) by reference to a decision data structure in which there are assigned action intensity values to particularly predicted provisioning actions. Scoring values assigned by manager system 110 under factor FV4 can be assigned according to the decision data structure of Table A, when predicted action confidence level intensity value are all considered in deriving an output scoring value under factor FV4.

TABLE A

| Provisioning | Intensity | Confidence | Assigned scoring value |
|---|---|---|---|
| action | multiplier | level | under factor FV4 |
| Contact list | 0.1 | XX | XX |
| Camera functionality | 0.3 | XX | XX |
| Full smartphone | 0.9 | XX | XX |
| function emulation | | | |

Referring to factor FV5, factor FV5 can be a security factor. Manager system 110 can assign scoring values under factor FV5 using the decision data structure of Table B.

TABLE B

| | | | | | | Assigned |
|---|---|---|---|---|---|---|
| | | | | | | scoring value |
| | | | | | | under |
| Provisioning | Security | Confidence | Environment | Other attendees | Security | security |
| action | multiplier | level | multiplier | multiplier | factor | factor FV5 |
| Active | 0.8 | XX | XX | XX | XX | XX |
| contact list | | | | | | |
| Camera | 0.3 | XX | XX | XX | XX | XX |
| functionality | | | | | | |
| Full | 0.9 | XX | XX | XX | XX | XX |
| smartphone | | | | | | |
| function | | | | | | |
| emulation | | | | | | |

Manager system 110 for factor FV 5 can determine a security factor by applying a security factor based on one or more predicted provisioning activities output by predictive model 4101 and then multiplying by other factors including confidence level associated to the predicted provisioning activity, an environmental multiplier, and an other attendees multiplier. Manager system 110 can scale the environmental multiplier to relatively higher values for where the current environment is less secure (e.g., a public venue) than more secure venues (business, or private residence). Manager system 110 can scale the other users multiplier to relatively higher values for where the other users are less secure (e.g., are strangers not on a contacts list associated to the current user) than more secure other users (other users are known users on a contacts list of the current user). Manager system 110 can scale a security factor for a predicted one or more provisioning action output by predictive model 4101 so that actions with higher security risk are assigned higher security risk factors, and manager system 110 can assign scoring values under factor FV5 as an inverse of the security risk factor, in order to bias prompted actions in favor of actions that pose reduced security risk.

Referring to factor FV6, factor FV6 can be a tournament factor. Manager system 110 for assigning scoring values under factor FV6 can subject detected articles detected within a scene to tournament selection evaluating and can scale assigned scoring values to detected articles according to tournament selection scoring.

For tournament selection scoring of detected articles, each of a set of candidate articles can be combined together into a cross product of sets including import itertools; stuff=[1, 2, 3]; for L in range(len(stuff)+1); for subset in itertools.combinations(stuff, L): print(subset). As a foundational element, the enhanced bracket, bₑ, models the most likely outcomes for tournament style play including the final champion of article sets. There can be created from a tournament draw or sets of articles seeded based on priority, dₜ, and all preselected items, m_{f}. A simulator from Algorithm 1 produces the enhanced bracket by predicting the winner of each match using an Elo based Watson Power Index, wpi_{elo,p}.

$${b}_{e} ( {d}_{t} , {m}_{f} ) = {sim}_{t} ( {d}_{t} , {m}_{f} ) \qquad ( 1 )$$

### Algorithm 1

Input: The current round, cᵣ, the set of matches within the draw of sets of articles, dₜ, the finished matches, m_{f}, the latest WPI for each set of articles, wpi_{p,r}. Output: A populated enhanced bracket, be, with predictions, Prₓ, for each match and WPI Elo for each article, wpi_{elo,px,r}, for r=cᵣ:do; for m=1:M; mϵr do p₁, p₂ϵm if r==cᵣ:wpi_{elo,pi,r}=swpi_{p1,r} from Eq. (2) wpi_{elo,p2,r}=swpi_{p2,r} from Eq. (2) else: lookup previous match node mn_{r-1,m}=bₑ[r−1, p₁, p₂] lookup p₁, p₂, Pr₁, Pr₂, wpi_{elo,p1,r-1,} wpi_{elo,p2,r-1} from mn_{r-1,m} update wpi_{elo,p1,r1} and wpi_{elo,p2} using (3) compute probability of win for each opponent item set, Pr₁ and Pr₂, using (5) update data structure mn_{r,m}={r, m, p₁, p₂, Pr₁, Pr₂, wpi_{elo,p1,r}, wpi_{elo,p2,r}}; mn_{r,m}ϵ_{be}. Each item set will have a Watson Power Index (WPI), wpiₚ, that has been computed by an external system. Throughout the enhanced bracket and as play continues, an Elo based WPI, wpi_{elo,p,r}, will be determined for each item set. In the current round, Algorithm 1 will use the scaled WPI for each item set, swpiₚ, calculated from Eq. (2).

$${swpi}_{p , r} = 400 - \frac{( max ( {wpi}_{p , r} ) - min ( {wpi}_{p , r} ) ) ( {wpi}_{p , r} )}{400} \qquad ( 2 )$$

In all other rounds, the wpi_{elo,pi,r} will be updated according to Eq. (3). The k factor determines how much the single match is worth while tₚ_{ₓ}_{,p}_{_{y}} is 1 if x beats y or 0 otherwise.

$${wpi}_{elo , px , r} = {wpi}_{elo , px , r - 1} + k ( {t}_{{p}_{x} , {p}_{y}} - {Pr}_{x} ( {p}_{x} beats {p}_{y} ) ) ; k ∈ [ 0 , 1 ] ; {t}_{{p}_{x} , {p}_{y}} = \{ 1 , 0 \} \qquad ( 3 )$$

$$k = \qquad ( 4 )$$

Now, the probability that an article will defeat another article is shown in Eq. (5). Both of the WPI Elo values represent each item set's strength going into the next match.

$${Pr}_{x} ( {p}_{x} beats {p}_{y} ) = \frac{1}{1 + 10 \frac{- ( {wpi}_{elo , {p}_{x} , r} - {wpi}_{elo , {p}_{y} , r} )}{400}} ; {p}_{x} ⋃ {p}_{y} = \{ p 1 , p 2 \} \qquad ( 5 )$$

Algorithm 1 continues and applies Eq. (2)-(5) until all matches within the enhanced bracket, bₑ, are predicted. Path to article Selection. With the enhanced bracket, bₑ, structure populated as described in the Enhanced Bracket section, each article set will have an odds for winning the tournament, champₚ. Algorithm 2 shows the method for calculating the Pr_{champ,x}.

### Algorithm 2

Input: A populated enhanced bracket, be, with predictions, Prₓ, for each match and WPI Elo for each item set, wpi_{elo,px,r}. Output: A path to the championship, path_{champ,x}, and the probability that each item set will be the champion, Pr_{champ,x}. for p=P:bₑ do trace item set, p, to the championship for traceₚ for mn_{r,m}ϵtraceₚ do lookup mn_{r,m} if Prₓ>Pr_{y} and x=p in mn_{r,m}: continue
else: move item set, p, to the next match and update a copy of bₑ update wpi_{elo,p,r}=swpi_{p1,r} from Eq. (2) compute the probability of win, Prₚ, for article, p, for the next match using (5) update copy of bₑ and traceₚ append match mn_{r,m} to the path_{champ,x}
compute Pr_{champ,x} using (6)

A trace search can be performed for each article set, traceₚ, through the enhanced bracket, be, while updating a local copy of bₑ. Through the trace search, if an article set is predicted to lose, the article set will be forced forward into the next match. The local copy of the bₑ and the traceₚ will be updated according to the steps in Algorithm 2. After the full article trace, the probability of the article winning the tournament will be computed with Eq. (6).

$${Pr}_{champ , x} = {\prod }_{m}^{{b}_{e}} P {r}_{x} ( {p}_{x} beats {p}_{y} ) ; {p}_{x} , {p}_{y} ∈ m . \qquad ( 6 )$$

Now, we will have both the selected item sets that will win the tournament or selection for transfer into the virtual space and also the odds of every other item set. The Watson Power Index for each article set can be determined by a set of generative pretrained transformer. Each item within the item set is routed to a transformer. For images, a convolutional neural network (CNN) can compute an embedding that is sent to a transformer that outputs and secondary embeddings. For sound, spectrograms are created and processed by a CNN, which creates an embedding. This embedding is input into a sound-based transformer for secondary embeddings. The text is input into a word embedding and then processed by a text-based transformer for a secondary embedding. Finally, video is processed frame by frame with sound, which can be averaged together across embeddings and input into a video transformer for a secondary embedding. Next, the secondary embeddings are truncated together. From here a task based prompt is appended to the embedding that tells the next transfer the task such: 1) Tell me the importance of the video, images, sound, and text: <embeddings>; 2) Tell me the importance of the images: <embeddings>; 3) Tell me the importance of the text: <embeddings>; Etc. The importance levels of the article sets are then assigned as the Watson power index for the article set. The attention weights are for the multihead attention pieces in the final transformer. The attention weights indicate which parts of the embeddings are more important, as does the user finding images more important than words.

Referring to generating block 1110, manager system 110 can generate prompting data in dependence on an overall scoring value according to scoring formula A.

In one example, manager system 110 can refrain from presenting any prompting data on a user interface main screen 3116 prompting provisioning data action unless the scoring value satisfies the threshold value. In this example, it can be seen if a virtual article encountered in virtual reality space has no corresponding physical world article, factor FV1 can be driven to a significantly low value, such that the threshold may not be triggered and no prompting provisioning data action may be presented on user interface main screen (rather, the prompting data 3102, 3112, 3122 may be accessible via menu 3118). In another example, prompting data for prompting provisioning can be presented on main screen 3116 irrespective of a scoring formula A scoring value. In another example of generating at block 1110, manager system 110 can provide the decision to auto provision, and not generate any prompting data where the scoring value determined under scoring formula A satisfies a scoring threshold value for auto provisioning. Embodiments herein recognize that certain historical behaviors can be so indicative of provisioning of a user deciding to provision a virtual world article that prompting for such provisioning can be avoided and manager system 110 can proceed directly to reprovisioning the virtual world article without first prompting for the reprovisioning.

Referring to generating block 1107, manager system 110 can generate prompting data in dependence on an overall scoring value according to scoring formula A. For generating virtual world prompting data, manager system 110 can use the decision data structure of Table C.

TABLE C

| Row | SV scoring value | Prompting data characteristic |
|---|---|---|
| 1 | 0.0 <= SV <= 0.3 | Prompting data 3102, 3112, 3122, is |
| | | hidden from user interface main screen |
| | | 3116 but accessible via menu 3118 |
| 2 | 0.3 <= SV <= 0.6 | Prompting data 3102, 3112, 3122 is |
| | | displayed as shown in FIG. 3A-3B |
| 3 | 0.6 <= SV <= 0.9 | Prompting data 3102, 3112, 3122 is |
| | | displayed as shown in FIG. 3A-3B with |
| | | highlight (e.g., enlarged font, flashing, |
| | | different color, etc.) |
| 4 | 0.9 <= SV <= 1.0 | Physical article is auto-provisioned |
| | | according to the predicted most likely |
| | | provisioning action |

According to one example, manager system 110 at generating block 1110 can generate prompting data, according to a scoring value determined using scoring formula A. In one example, manager system 110 can configure a presentation of prompting data in dependence on a scoring value determined using scoring formula A, e.g., generating prompting data of a font size scaled in dependence on a scoring value determined using scoring formula A.

In another example of generating at block 1110, manager system 110 can generate prompting data in dependence on an output responsive to query data applied to querying a predictive model 4102. For example, querying a predictive model 4102 can produce a variety of alternative functional behavior provisioning data actions of a user with respect to a detected article, each having a different level of confidence. In one example, provisioning data predictive model 4102 can output a variety of different predicted functional behavior provisioning data actions each with corresponding different confidence levels.

Manager system 110 in performing generating at block 1110 can present text based prompting data 3102, according to a ranked order of predicted actions output from predictive model 4102 in accordance with confidence, wherein the ranking is determined by the associated confidence levels of each predicted action. With such generated prompting data, a user can be expected to be more prominently prompted with respect to an action specified in text displayed on a higher order of displayed prompting data. In one illustrative use case where manager system 110 predicts that a user will take active contact list functional behavior provisioning data action at 75% confidence and camera usage provisioning functional behavior data action at 45% confidence level, manager system 110 within text based prompting data 3102 can present prompting variable data text 3103 to specify the active contact list functional behavior at a higher elevation (the elevation of variable prompting data text 3103) within the text based prompting data 3102 than the variable prompting data text 3104 configured in the example described to specify an alternative action camera usage functional behavior (at the elevation of the variable text 3104). Variable prompting data text 3103, 3102, 3103, 3113, 3114, 3115, 3123, 3124, 3125, 3133, 3134, 3135, 3143, 3144, 3145, 3153, 3154, 3155 shown throughout the views can specify a discrete functional behavior of a virtual article (FIG. 3A-3B), or physical article (as shown in FIG. 3C-3D). The instances of variable prompting data text 3103, 3102, 3103, 3113, 3114, 3115, 3123, 3124, 3125, 3133, 3134, 3135, 3143, 3144, 3145, 3153, 3154 can define active text buttons such that provisioning according to the specified functional behavior is activated when a user actuates (e.g., by pressing) the variable prompting data text.

At generating block 1110, manager system 110 can ascertain whether an article classifier for the article detected at block 1109 matches an article classifier for a physical world article previously encountered by the user during a historical physical world session. For performing such ascertaining, manager system 110 can read metadata labels associated to an instantiated virtual article rendered in the virtual environment and can compare that label to, e.g., to a label returned by way of an image recognition process in the physical world, as explained with reference to recognition process 116 and/or labels returned from processing of radio signal data, e.g., which references address information that maps the specific physical world article according to registration data input by user on registration into manager system 110.

At send block 1111, manager system 110 can send the prompting data to the user, e.g., using UE device 1301 the generated prompting data that was generated at block 1110. In response to receipt of the generated prompting data, the user using the UE device, i.e., UE device 1301 of FIG. 1 in the described example can specify selection data.

At block 1112, manager system 110 can ascertain whether the selection data sent at block 2307 has specified the action of proceeding with the provisioning of a physical article of a user based on functionality of a corresponding virtual article of the user. On determination that the user has specified such selection data, manager system 110 can proceed to block 1113. At block 1113, manager system 110 can send request data to the appropriate UE device of the user, e.g., UE device 1301 shown in FIG. 1 requesting the sending by the UE device of configuration data to manager system 110 that specifies a state of the relevant physical article. On receipt of the request data sent at block 1113 the appropriate UE device of the user, e.g., UE device 1301 can send configuration data to manager system 110 on receipt at send block 2308. On receipt of the configuration data sent at block 2308, manager system 110 can proceed to perform provisioning of the virtual world article subject to article detection of the preceding instance of block 1109; in this case, the virtual smartphone represented as smartphone 1301R depicted in FIG. 1. Manager system 110 for performing the provisioning can query virtual provisioning data area 2124 for return of appropriate provisioning data for emulation of the selected functional behavior of the user and can reprogram virtual reality process 111 using the provisioning data.

On completion of provisioning block 1114, manager system 110 can proceed to recording block 1115. At recording block 1115, manager system 110 can record relevant data associated to the virtual article detection detected at block 1109, in the described example, the smartphone represented by smartphone 2301R depicted in FIG. 1. The recorded virtual article data can include the types of data described with reference to an iteration of training data for training provisioning data predictive model 4102. For example, the recorded article data recorded at block 1115 can include article data, such as article classifier, article usage classifier, article data action classifier, i.e., the selected action for provisioning a functional behavior selected with the selection data sent at block 2308 and attendees classifier for the current virtual article detection in environment classifier. At recording block 1115, manager system 110 can record the virtual article event of the user into virtual article history area 2122.

On completion of recording block 1115, manager system 110 can proceed to training block 1116. At training block 1116 manager system 110 can retrain predictive model 4102 using the just-recorded provisioning data recorded at block 1115. It will be seen that subsequent provisioning prompting data presented to the current or an other user can be generated in dependence on the retraining.

There is set forth herein in one embodiment, a method wherein, with a user engaged in a user session within a first environment, examining historical data of the user, wherein the examining historical data of the user includes examining historical data of a previously recognized article of the user previously recognized in a second environment; and provisioning an article of the user within the first environment to include a functional behavior, wherein an article of the user within the first environment includes an article type classification in common with the previously recognized article, and wherein the provisioning the article to include the functional behavior is performed in dependence on a result of the examining the historical data of the user. There is further set forth herein, with reference to the described method, wherein the provisioning the article to include the functional behavior is performed in dependence on a result of examining historical data of the previously recognized article of the user previously recognized in the second environment, wherein the historical data of the user includes historical data of the article of the user within the first environment, wherein the provisioning the article to include the functional behavior is performed in dependence on a result of examining the historical data of the article of the user within the first environment, examining historical data of the previously recognized article of the user previously recognized in the second environment includes examining data on bytes of provisioning data used for provisioning the previously recognized article of the user in sessions of the second environment, examining a recency with which the previously recognized article of the user was recognized, examining a frequency with which the previously recognized article of the user was recognized in sessions of the second environment, wherein the examining historical data of the article of the user within the first environment includes querying a predictive model that has been trained with machine learning training data of historical sessions in the first environment, wherein the machine learning training data of historical sessions of the user in the first environment includes data of historical sessions of a crowdsourced collection of users other than the user, wherein the method includes identifying a first candidate functional behavior of the article, and identifying a second candidate functional behavior of the article of the user in the first environment, wherein the method includes evaluating security risk associated to the first candidate functional behavior of the article of the user in the first environment, the evaluating security risk associated to the first candidate functional behavior of the article including evaluating use of a counterpart physical article of the article in the physical environment, and evaluating security risk associated to the second candidate functional behavior of the article, wherein the method includes generating prompting data in dependence on the examining historical data of the previously recognized article of the user previously recognized in a second environment, wherein the prompting data specifies the first candidate functional behavior and the second candidate functional behavior, wherein the prompting data includes an indicator of a determined security risk of the first candidate functional behavior, and wherein the prompting data includes an indicator of a determined security risk of the second candidate functional behavior, and wherein the prompting data indicates differentiated security risk associated to the first candidate functional behavior and the second candidate functional behavior, respectively, wherein the provisioning is activated in response to the user selecting one of the first candidate functional behavior or the second candidate functional behavior specified by the prompting data, and wherein the method includes responsively to the user selecting the one of the first candidate functional behavior or the second candidate functional behavior specified by the prompting data, recording provisioning data of the provisioning, wherein the provisioning data of the provisioning includes an other users classifier, an environment classifier and a data action classifier specifying a provisioned functional behavior selected by the selecting, wherein the method includes further training the predictive model using the other users classifier, an environment classifier and a data action classifier specifying a provisioned functional behavior, detecting a virtual article in virtual reality session of a second user, and, in response to the detecting the virtual article presenting subsequent prompting data to the second user, wherein the subsequent prompting data is generated in dependence on a subsequent query of the predictive model as further trained in dependence on the further training using the other users classifier, an environment classifier and a data action classifier specifying a provisioned functional behavior.

On completion of training block 1116, manager system 110 can proceed to session end block 1117. At session end block 1117, manager system 110 can ascertain whether a user has terminated the current virtual reality session. On the determination that the user has not terminated the current virtual reality session, manager system 110 can return to the stage prior to block 1108 to send a next iteration of virtual reality presentation data in furtherance of the current virtual reality session and manager system 110 can iteratively perform the loop of blocks 1108-1117 for a time that the current virtual reality session remains active.

It will be seen that in a subsequent iteration of the loop of blocks 1108-1117, manager system 110 at an iteration of block 1109 in the described example described in reference to FIG. 1 can detect the appearance of the IoT bicycle represented in the virtual world environment of FIG. 1 as virtual IoT bicycle 1302R depicted in FIG. 1 at a subsequent stage of the virtual reality session described wherein the IoT bicycle as described in reference to FIG. 3B. On the detection of the IoT bicycle, manager system 110 can present subsequent prompting data 3122 as set forth in FIG. 3B which prompting data can be generated in the manner described in reference to generating block 1110, except this time with respect to the differently detected virtual world article, namely the IoT bicycle depicted in FIG. 1. For the different IoT bicycle article, different provisioning options can apply, e.g., upload route history, upload maps, upload riding friends, synchronize riding history, and the like. The different options can be specified within the variable text “XXXX” of defining prompting data, wherein each option is specified by variable text at a different elevation 3123, 3124, or 3125 depending on the confidence level of the option being selected as determined by querying of predictive model 4102.

Manager system 110 can iteratively perform the loop of blocks 1108-1117 for detection of new articles and generation of prompting data with respect to the same for provisioning functionality of such articles for a duration of a virtual reality session. On determination at block 1117 by manager system 110 that a user has terminated a virtual reality session, manager system 110 can proceed to block 1118. At block 1118, manager system 110 at send block 1118 can send virtual reality session data for receipt by the appropriate UE device, e.g., UE device 1301 depicted in FIG. 1, as well as configuration data specifying state of virtual articles of the just terminated virtual reality session. The UE device having exited the terminated virtual reality session can commence a new physical world session described in reference to blocks 2310-2316 of FIGS. 2A to 2C.

On receipt of the session data and configuration data sent at block 1118, UE device 1301 can commence a new physical world session. At block 2310, UE device 1301 can ascertain whether a physical article has been detected in the physical environment of the user. On the determination that a physical article has been detected, UE device 1301 can send signaling data to manager system 110 at send block 2311 and manager system 110 can responsively proceed to generating block 1119.

At generating block 1119, manager system 110 can identify a virtual world article corresponding to the physical world article detected at block 2310. At generating block 1119, manager system 110 can ascertain whether an article classifier for the physical article detected at block 2310 matches an article classifier for a virtual article previously encountered by the user during a virtual reality session. For performing such ascertaining, manager system 110 can read metadata labels associated to an instantiated virtual article rendered in the virtual environment and can compare that label to, e.g., to a label returned by way of an image recognition process in the physical world, as explained with reference to recognition process 116 and/or labels returned from processing of radio signal data, e.g., which references address information that maps the specific physical world article according to registration data input by user on registration into manager system 110. While image recognition can be performed by processing a camera image captured by user a smartphone as depicted in FIG. 3C, image recognition alternatively be performed with use of a video camera system operated by manager system 110 and subject to recognition processing by recognition process 116, wherein the video camera system is disposed in a physical environment of the user.

At generating block 1119, manager system 110 can generate prompting data that prompts the user to provision a detected physical article with provisioning data that configures a functional behavior of the detected physical world article. In generating of prompting data at generating block 1119, manager system 110 can apply scoring formula B as follows.

SP=FP1W1+FP2W2+FP3W3+FP4W4+FP5W5 (scoring formula B)

Where SP is a scoring value for scoring the current user's interaction with the physical article in the current physical world session, FP1 is a first factor, FP2 is a second factor, FP3 is a third factor, FP4 is a fourth factor, FP5 is a fifth factor, and W1-W5 are weights associated to the various factors.

In one embodiment, FP1 can be a recency factor, FP2 can be a frequency factor, FP3 can be a provisioning factor, FP4 can be a predictive model factor, and FP5 can be a security factor. Manager system 110 applying scoring values under factor FP1 can assign and scale scoring values in dependency on a recency which the user last interacted with a counterpart of the detected physical world article in a virtual reality session.

FIG. 3C depicts presentment of a user interface presented to a user, e.g., on a display of UE device 1301 in the described example on commencement of a physical world session corresponding to the physical world session depicted on a high level in FIG. 1. At the commencement of a physical world session, the user 101 (FIG. 1) in the described example represented as represented user 1301R in the virtual session can be holding a smartphone UE device corresponding to smartphone UE device 1301 shown in FIG. 1.

On detection of the physical world smartphone depicted as UE device 1301 in FIG. 1, manager system 110 can perform generating of prompting data 3102 as shown in the user interface of FIG. 3A prompting the user to perform functional provisioning of the depicted smartphone article. In assigning scoring values under factor FP1, the recency factor, manager system 110 can ascertain a last time that a user encountered a virtual world article corresponding to the depicted article 1301 in the physical world session. On such determining, manager system 110 can ascertain that at the last virtual reality session terminated at block 1117 the user encountered virtual smartphone 1301R depicted in FIG. 1 and can scale a scoring value assigned under factor FP1 according to the time lag between the time of the detection of the depicted article 1301R during the last virtual reality session of the user and the current time of detection of the physical article detected at block 2309.

With further reference to scoring formula B, manager system 110 at generating block 1119 can scale scoring values under frequency factor FP2 in dependence on a frequency with which a virtual world article corresponding to the detected physical article detected at block 2310 was detected in prior virtual reality sessions of the user. For example, where a detected physical world article is a smartphone which was detected during 45 percent of cumulative (over multiple sessions) prior virtual reality session time of the user, manager system 110 can assign a scoring value of 0.45 under frequency factor FP2. Where a detected physical world article is an IoT bicycle which was detected during 15 percent of cumulative (over multiple sessions) prior virtual reality session time of the user, manager system 110 can assign a scoring value of 0.15 under frequency factor FP2.

With further reference to scoring formula B, manager system 110 at generating block 1119 can assign scoring values under factor FP3 in dependence on historical provisioning by the user of the physical article detected at block 2310 and any physical counterpart of the physical article in an historical virtual reality session of the user. Manager system 110 at generating block 1119 can scale scoring values under factor FP3 according to the cumulative bytes of historical provisioning data transferred to a detected physical world article for provisioning a functional behavior attribute of the detected article and/or transferred to a virtual reality engine that configures a counterpart virtual world article of the currently detected physical world article for provisioning a functional behavior attribute of the counterpart virtual world article.

With further reference to scoring formula B, manager system 110 at generating block 1119 can assign scoring values under factor FP4 in dependence on an output resulting from query of provisioning data predictive model 4202 as shown in FIG. 4B. Provisioning data predictive model 4202 can predict a provisioning functional behavior provisioning data action of a user with respect to a detected physical world article. Provisioning data predictive model 4202 can be trained with historical session data associated to a current user as well as a crowdsourced collection of other users of system 100 and manager system 110. Provisioning data predictive model 4202 can be trained with historical data of historical physical world sessions of a current user as well as a crowdsourced collection of all other users of system 100 and manager system 110. Provisioning data predictive model 4202 can be trained with training data and once trained can be responsive to query data for return of predictions as to what actions a user will take with respective provisioning a detected physical article.

Predictive model 4202 as shown in FIG. 4B can be trained with iterations of training data, wherein each iteration comprises (a) an article classifier of an article detected in a certain historical physical world session; (b) an article usage classifier that specifies one or more usage classification of a user with respect to the article in the certain historical physical world session; (c) an article data action classifier that specifies one or more functional behavior provisioning data action of the user with respect to the article in the certain historical physical world session; (d) an accompanying articles vector that specifies identifiers for other articles in the environment of certain article during the certain historical physical world session; (e) an attendees classifier that specifies a classification of attendees accompanying the user during detecting of the article during the historical physical world session; (f) an environmental classifier for the environment encountered by the user on the detecting of the article during the historical physical world session; and (g) a user classifier that specifies the classification of user encountering the article detected during the historical virtual reality session. The described training can be performed for multiple, e.g., tens, thousands, millions of physical world sessions in which an article was detected and encountered by the current user and/or crowdsourced collection of other users. Embodiments herein recognized that by training predictive model 4202 with training data that specifies characteristics associated to past physical article provisioning events, predictive model 4202 is able to learn trends influencing user action in terms of provisioning a physical article.

The article classifier can be a classifier for an article during an historical physical world session, e.g., smartphone as described with reference in the example of FIG. 3C. The article usage classifier can refer the usage of the detected article during the historical physical world session, e.g., holding, browsing, telephone calling, texting, and the like. The article functional behavior provisioning data action classifier can refer to the provisioning of the physical article by historical user in an historical session mediated by manager system 110. The accompanying articles vector can specify identifiers for other articles in the environment of certain article during the certain historical physical world session. The attendees classifier can classify for attendees in the environment of the user during an historical physical world session. Attendees classifiers can be, e.g., no other attendees, one other attendee friend, one other attendee stranger, multiple other attendees friends, multiple other attendees strangers, and so on. Environmental classifiers can include, e.g., outside, residence, work environment, article acquisition venue and the like. The user classifier for training provisioning data predictive model 4102 can be based on clustering analysis, wherein manager system 110 identifies clusters of similar users based on preferences of such users of system 100 and manager system 110. For ascertaining classifications of different users, manager system 110 can query an output of clustering analysis for use in determining similar users as has been described in reference to FIGS. 5A-5B.

Predictive model 4202 once trained can be capable of returning predictions. For example, with reference to FIG. 4B, provisioning data predictive model 4202 can be queried with query data that specifies a detected physical world article classifier, an article usage classifier, an accompanying articles vector, an attendees classifier, an environmental classifier, and a user classifier for the current physical world session for which prompting data is generated at block 1119. In response to the query data, provisioning data predictive model 4202 can generate a predicted provisioning action of a user, e.g., whether the user based on historical sessions of other users and/or the current user will provision a current physical world article, e.g., smartphone to assume new behavior, e.g., new functional behavior, e.g., contact list functionality, e.g., with auto contacting phone functionality, texting functionality, browsing functionality, picture taking functionality, and the like. Trained as described, provisioning predictive model 4202 is able to predict possible provisioning actions of a user with respect to a currently detected physical world article. Manager system 110 in generating predicted provisioning actions can assign confidence levels associated to the various predictions. The confidence level, in one example, can be dependent on trends observed and on a volume of training data supporting a certain prediction.

Manager system 110 can scale scoring values under factor FP4 by reference to a decision data structure in which there are assigned action intensity values to particularly predicted provisioning actions. Scoring values assigned by manager system 110 under factor FP4 can be assigned according to the decision data structure of Table D, when predicted action confidence level intensity value are all considered in deriving an output scoring value under factor FP4.

TABLE D

| Provisioning | Intensity | Confidence | Assigned scoring value |
|---|---|---|---|
| action | multiplier | level | under factor FP4 |
| Maps download | 0.1 | XX | XX |
| Trips history | 0.3 | XX | XX |
| Health biometric data | 0.3 | XX | XX |
| download | | | |
| Full IoT bicycle | 0.9 | XX | XX |
| emulation | | | |

Referring to factor FP5, factor FP5 can be a security factor. Manager system 110 can assign scoring values under factor FV5 using the decision data structure of Table E.

TABLE E

| | | | | | | | Assigned |
|---|---|---|---|---|---|---|---|
| | | | | | | | scoring |
| | | | | | | | value |
| | | | | | | | under |
| | | | | Other | Other | | security |
| Provisioning | Security | Confidence | Environment | attendees | world | Security | factor |
| action | multiplier | level | multiplier | multiplier | factor | factor | FV5 |
| Maps | 0.3 | XX | XX | XX | XX | XX | XX |
| download | | | | | | | |
| Trips | 0.5 | XX | XX | XX | XX | XX | XX |
| history | | | | | | | |
| Health | 0.8 | XX | XX | XX | XX | XX | XX |
| biometric | | | | | | | |
| data | | | | | | | |
| download | | | | | | | |
| Full IoT | 0.9 | XX | XX | XX | XX | XX | XX |
| bicycle | | | | | | | |
| emulation | | | | | | | |
| Total | | | | | | XX | XX |

Manager system 110 for factor FP5 can determine a security factor scoring value by applying a security factor based on one or more predicted provisioning activities output by predictive model 4202 and then multiplying by other factors including confidence level associated to the predicted provisioning activity, an environmental multiplier, and an other attendees multiplier. Manager system 110 can scale the environmental multiplier to relatively higher values for where the current physical world environment is less secure (e.g., a public venue) than more secure venues (business, or private residence). Manager system 110 can scale the other users multiplier to relatively higher values for where the other users are less secure (e.g., are strangers not on a contacts list associated to the current user) than more secure other users (other users are known users on a contacts list of the current user). According to the physical world multiplier, manager system 110 can scale a physical world factor in dependence on exposure of a corresponding physical world article to other users. For such multiplying, manager system 110 can evaluate one or more of (a) total time that other users were in the environment of the corresponding physical article, (b) classifications of such other users (e.g., contacts or strangers, and can assign higher risk for strangers), and/or (c) type of action, e.g., can assign highest risk where an other user handled and used the particularly referenced functional behavior of the corresponding physical article, can assign next highest risk where the other user used the corresponding physical article but did not use the particular functional behavior, and can assign next highest risk where the other user merely was in the environment of the corresponding physical article but did not use the corresponding physical article. Manager system 110 can scale a security factor for a predicted one or more provisioning action output by predictive model 4202 so that actions with higher security risk are assigned higher security risk factors, and manager system 110 can assign scoring values under factor FP5 as an inverse of the security risk factor, in order to bias prompted actions in favor of actions that pose reduced security risk. Manager system 110 can use the total value of Table E for assigning scoring values under factor FP5 which can trigger general prompting data decisions as set forth in the decision table of Table F. Manager system 110 can use the individual functional behavior scoring values of table E for formatting decisions resulting in prompting data that specifies differentiated security risk associated to different candidate functional behaviors. For example, manager system 110 can format variable prompting data text 3103, text 3104, and text 3105 specifying different functional behaviors at the different elevations depicted in FIG. 3A differently in dependence on determined security risk. For example, manager system 110 can format text specifying candidate functional behaviors for provisioning with highest security risk in red font, can format text specifying candidate functional behaviors for provisioning with medium security risk in yellow font, and can format text specifying candidate functional behaviors for provisioning with medium security risk in green font.

Referring to generating block 1119, manager system 110 can generate prompting data in dependence on an overall scoring value according to scoring formula B. For generating physical world prompting data, manager system 110 can use the decision data structure of Table F.

TABLE F

| Row | SP scoring value | Prompting data characteristic |
|---|---|---|
| 1 | 0.0 <= SP <= 0.3 | Prompting data 3132, 3142, 3152, is |
| | | hidden from user interface main screen |
| | | 3136 but accessible via menu 3138 |
| 2 | 0.3 <= SP <= 0.6 | Prompting data 3132, 3142, 3152, is |
| | | displayed as shown in FIG. 3C-3D |
| 3 | 0.6 <= SP <= 0.9 | Prompting data 3132, 3142, 3152, is |
| | | displayed as shown in FIG. 3C-3D with |
| | | highlight (e.g., enlarged font, flashing, |
| | | different color, etc.) |
| 4 | 0.9 <= SP <= 1.0 | Physical article is auto-provisioned |
| | | according to the predicted most likely |
| | | provisioning action |

In one example, manager system 110 can refrain from generating any prompting data for presentment on main user interface screen 3136 (FIG. 3C-3D) at block 1119 for prompting provisioning action unless the scoring value satisfies a threshold value (such prompting data 3132 can be accessible via menu 3138). In this example, it can be seen if a physical article encountered in physical real-world space has no corresponding virtual world article, factor FP1 can be driven to a significantly low value, such that the threshold may not be triggered, and no prompting functional behavior provisioning data action may be presented on main user interface screen 3136. In another example, prompting data for prompting provisioning can be presented on main screen 3136 irrespective of a scoring formula B scoring value. In another example of generating at block 1119, manager system 110 can provide the decision to auto provision, and not generate any prompting data where the scoring value determined under scoring formula B satisfies a threshold value for auto provisioning. Embodiments herein recognize that certain historical behaviors can be so indicative of provisioning of a user deciding to provision a physical article that prompting for such provisioning can be avoided and manager system 110 can proceed directly to reprovisioning the physical article without first prompting for the reprovisioning.

According to one example, manager system 110 at generating block 1107 can generate prompting data according to a scoring value determined using scoring formula B. In one example, manager system 110 can configure a presentation of prompting data in dependence on a scoring value determined using scoring formula A, e.g., generating prompting data of a font size that is scaled in dependence on a scoring value determined using scoring formula B.

In another example of generating at block 1119, manager system 110 can produce prompting data in dependence on an output responsive to query data applied to querying a predictive model 4202. For example, querying a predictive model 4202 can produce a variety of alternative predicted functional behavior provisioning data actions of a user with respect to a detected physical article, each having a different level of confidence. In one example, provisioning predictive model 4202 can output a variety of different predicted actions each with corresponding different confidence levels. Manager system 110 in performing generating at block 1119 can present text based prompting data 3132, according to a ranked order of predicted actions output from predictive model 4202 in accordance with confidence level, wherein the ranking is determined by the associated confidence levels of each predicted provisioning action. With such generated prompting data, a user can be expected to be more prominently prompted with respect to an action displayed on a higher order of displayed prompting data. In one illustrative use case where manager system 110 predicts that a user will select an active contact list functional behavior provisioning data action at a 75% confidence level, and camera functionality usage functional behavior provisioning data action at 45% confidence level, manager system 110 within text based prompting data 3132 (FIG. 3B) can display variable prompting data text 3133 specifying in the described scenario “active contact list” at a higher elevation (elevation of text 3133) within the text based prompting data 3132 than the variable prompting data text 3134 specifying the alternative action “camera functionality” (at elevation of text 3134).

At send block 1108, manager system 110 can send the prompting data to the user, e.g., using UE device 1301 the generated prompting data that was generated at block 1119, and prompting data 3132 can be responsively presented as shown in FIG. 3C. In response to receipt and presentment of the generated prompting data, the user using the UE device, i.e., UE device 1301 of FIG. 1 in the described example can specify selection data, which selection data can be defined by user 101 responsively the sending of prompting data at send block 1120.

At block 2312, UE device 1301 can ascertain whether the user responsively to the prompting data has specified the action of proceeding with the provisioning data transfer from a virtual article of a user to a corresponding physical article of the user. On determination that the user has specified such action, UE device 1301 can send request data to manager system 110 requesting configuration data of the appropriate corresponding virtual article. On receipt of the request data sent at block 2313, manager system 110 can send the requested configuration data to UE device 1301, which configuration data can specify a state of the corresponding virtual article. On receipt of the configuration data sent at block 1121, UE device 1301 can perform provisioning of the physical article subject to article detection at the preceding instance of block 2309; in this case, the smartphone UE device 1301. The provisioning can include querying manager system 110 with the received configuration data for return of appropriate physical provisioning data from physical provisioning data area 2125 and installing the provisioning in the relevant physical article.

On completion of provisioning block 2314, UE device 1301 can proceed to recording block 2315. At recording block 2315, UE device 1301 can record relevant data associated to the physical article detection detected at block 2310, in the described example, the smartphone represented by smartphone 1301 depicted in FIG. 1. The recorded physical article data can include the types of data described with reference to an iteration of training data for training provisioning predictive model 4202. For example, the recorded article data recorded at block 2315 can include article data, such as article classifier, article usage classifier, article provisioning action classifier (i.e., the selected action for provisioning selected with the selection data defined by user 101 responsively to the presentment of prompting data 3132) an attendees classifier, an environment classifier.

On completion of recording block 1112, UE device 1301 can proceed to session end block 2316. At session end block 2316, UE device 1301 can ascertain whether a user has terminated the current physical world session by selecting a next virtual reality session. On the determination that the user has not terminated the current physical world session, UE device can return to the stage prior to block 2310 and UE device 1301 can iteratively perform the loop of blocks 2310-2316 for a time that the current physical world session remains active.

It will be seen that in a subsequent iteration of the loop of blocks 2310-2316, manager system 110 at an iteration of block 2310 in the described example described in reference to FIG. 1 can detect the appearance of the physical article IoT bicycle 1302. On the detection of the IoT bicycle 1302, manager system 110 can generate next prompting data 3152 as set forth in FIG. 3D which prompting data can be generated in the manner described in reference to generating block 1119, except this time with respect to the differently detected physical article, namely the IoT bicycle depicted in FIG. 1. For the different IoT bicycle article, different functional behavior provisioning options can apply, e.g., upload route history, upload maps, upload riding friends, synchronize riding history, and the like. The different functional behavior options can be specified within the variable text “XXXX” defining prompting data 3152, wherein each option is specified by variable prompting data text 3153, 3154, or 3155 at a different elevations depending on the confidence level of the option being selected as determined by querying of predictive model 4102.

In reference to generating 1110, manager system 110 can generate prompting data for prompting provisioning action in response to detection of a virtual world article. In another embodiment, generating at block 1110 can be triggered in dependence on manager system 110 predicting that the user wishes to invoke a certain virtual article, and then manager system 110 can responsively generate prompting data for provisioning that certain virtual article. FIG. 4C depicts an article instantiation predictive model 4302 which can be configured to generate predictions that a user wishes to instantiate a virtual article. Article instantiation predictive model 4302 can be trained with iterations of training data and once trained article instantiation predictive model 4302 is able to predict when a user wishes to instantiate a certain article. Article instantiation predictive model 4302 can be trained with an iteration of training data each time that an historical user of system 100 and manager system 110 uses menu 3118 as shown in FIGS. 3A and 3B. Referring to FIGS. 3A and 3B, menu 3118 can be configured so that when a user accesses menu 3118, a drop-down list of articles for instantiation can appear which is selectable by a user. Manager system 110 can be configured so that each time an historical user uses menu 3118 to instantiate a new virtual article that is not currently rendered within a scene, manager system 110 registers an article instantiation event and uses specifying data of the instantiation of that event as training data for training article instantiation predictive model 4302. An iteration of training data for training article instantiation predictive model 4302 can include an article classifier, i.e., the article selected for instantiation and accompanying articles vector listing identifiers for all articles within the scene currently rendered, e.g., referring to, e.g., in the case of FIG. 3B, the virtual smartphone and the virtual bicycle. Attendees classifier, i.e., in identifiers for attendees of an environment during an instantiation event, an environment classifier for the instantiation event, e.g., in office, in residence, outdoors, etc. and a user classifier as described in connection with user clustering predictive model 5102 as explained in reference to FIGS. 5A and 5B. Trained as described, article instantiation predictive model 4302 is able to learn a relationship between attributes of a current environment of a user and their influence on a user's decision to instantiate a new virtual article into a virtual reality environment. Trained as described, article instantiation predictive model 4302 is able to predict when a user wishes to instantiate a virtual article. Article instantiation predictive model 4302 once trained, is able to respond to query data. Query data for querying article instantiation predictive model 4302 can include, for the current scene, being generated by a virtual reality platform in accompanying articles classifier listing the currently rendered articles of a current environment. An attendees classifier listing an attendees classification for the current environment, an environment classifier for the current environment, e.g., in residence, in business, outdoors and a user classifier as explained with reference to FIGS. 5A and 5B. In response to the described query data, article instantiation predictive model 4302 can return a prediction as to an article that the user currently wishes to instantiate in a current virtual reality scene. In one embodiment, manager system 110 at block 1109, while ascertaining whether an article has been rendered, can be querying article instantiation predictive model 4302 in order to predict whether the user. In one embodiment, manager system 110 can proceed to generating block 1110 on predicting that a user wishes to instantiate a virtual article. In one example, the predicting can be qualified when a confidence level associated to the predicting satisfies a threshold. In addition to or in place of using predictive model 4302 for use in predicting that a user wishes to instantiate a virtual article, manager system 110 can apply the tournament scoring process set forth herein in reference to Eq. 1-Eq. 6 for predicting that a user wishes to instantiate a virtual article.

UE device 1301 can iteratively perform the loop of blocks 2310-2316 for detection of new physical articles and generation of prompting data by manager system 110 with respect to the same for provisioning functionality of such articles for a duration of a physical world session. On determination at block 2316 by UE device 1301 that a user has terminated a physical world session by requesting a virtual reality session, UE device 1301 can proceed to block 2317. At send block 2317, UE device 1301 can send physical world session data for receipt by manager system 110. With the sending of session data at block 2316, UE device can be sending virtual reality session initiate data, and configuration data of detected physical articles in the exited physical world session, wherein the configuration data can specify the state of the detected physical articles.

In response to receipt of the sent data sent at block 2317, manager system 110 can proceed to return block 1122. At return block 1122, manager system 110 can return to a stage preceding block 1105. Manager system 110 for its deployment period can be iteratively performing the loop of block 1105-1122 while simultaneously iteratively performing the loop of blocks 1101-1104 (to obtain registration data of users and to update their user profiles, and perform training). Manager system 110 can be simultaneously performing multiple instances of the loop of blocks 1105-1122 for multiple users. At an iteration of updating block 1105 subsequent to block 2317, manager system 110 can perform updating of physical article history area 2123 to include recorded physical article data recorded at block 2314 recorded during a just-exited physical world session. UE devices 130A-130Z can iteratively perform the loop of blocks 2301-2318 for a deployment period of UE devices 130A-130Z. Social medica system 140 can iteratively perform the loop of blocks 1401-1402 for a deployment period of social media system 140.

On completion of recording block 2315, manager system 110 on initiation of a VR session can proceed to training block 1106. At training block 1106, manager system 110 can retrain predictive model 4202 using the just-recorded provisioning data recorded at block 2315. It will be seen that subsequent physical world provisioning prompting data presented to the current or an other user can be generated in dependence on the retraining.

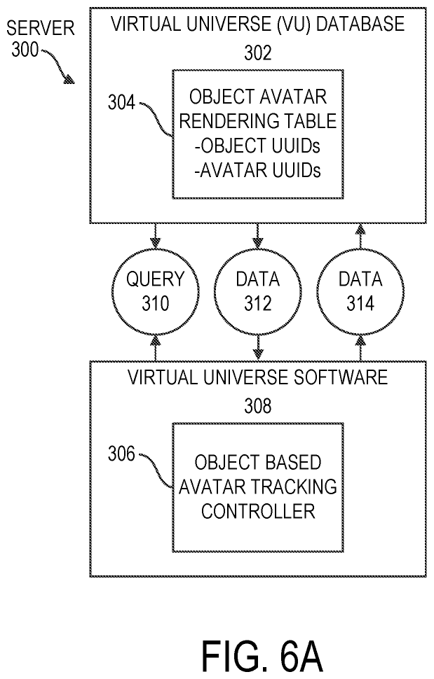

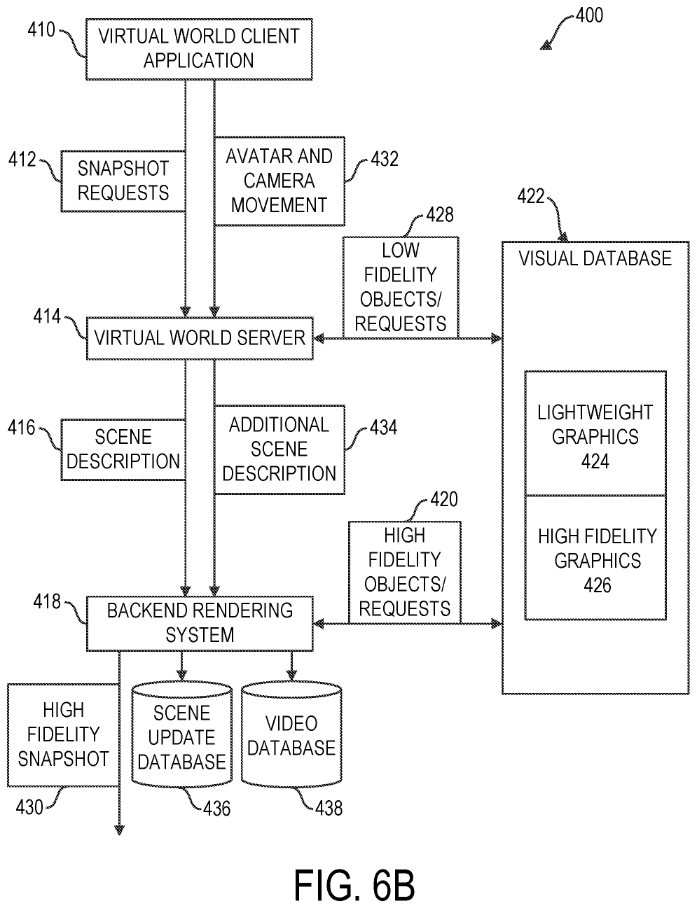

Manager system 110 running virtual world process 111 can include manager system 110 operating the system depicted in FIG. 6A. FIG. 6A is a block diagram illustrating a virtual world server in accordance with an illustrative embodiment. Server 300 is a server associated with a virtual world. Server 300 may be a single, stand-alone server, or server 300 may be a server in a virtual world computing system or in a cluster of two or more servers. In this example, server 300 is a server in a computing system for rendering and managing a virtual world.

Virtual world database 302 is a database on the computing system for storing data used by virtual world software 308 to render and manage the virtual world. Virtual world database 302 includes object avatar rendering (OAR) table 304. Object avatar rendering table 304 stores object universally unique identifiers and avatar universally unique identifiers. In a virtual world, assets, avatars, the environment, and anything visual consists of universally unique identifiers (UUIDs) tied to geometric data, textures, and effects data. Geometric data is data associated with the form or shape of avatars and objects in the virtual world. Geometric data may be used to construct a rendered mesh of an avatar or object. Geometric data is distributed to a user's client computer as binary coordinates. Textures are distributed to a user's client computer as graphics files, such as JPEG files. Texture data refers to the surface detail and surface textures or color that is applied to mesh geometric data to render the object or avatar. Effects data is typically rendered by the user's client according to the user's preferences and the user's client device capabilities, Object avatar rendering table 304 stores a universally unique identifier (UUID) for each selected object in the virtual world, A selected object is an object in a plurality of objects in the virtual world that is tracked, monitored, managed, or associated with object avatar rendering table 304. Object avatar rendering table 304 also stores universally unique identifiers and other data describing avatars within a viewable field of a selected object or within a selected zone or range associated with the selected object. For example, if the selected objects include object A and object B, then object avatar rendering table 304 stores object A universally unique identifier, universally unique identifiers and other data for all avatars and objects within selected range of object A, object B universally unique identifier, and universally unique identifiers and other data describing all avatars and objects within selected range of object B. Object based avatar tracking controller 306 stores data 314 in object avatar rendering table 304. Data 314 includes the universally unique identifiers and other data describing avatars within the viewable field of one or more selected objects. When object based avatar tracking controller 306 needs data from object avatar rendering table 304 for implementing geometric and texture modifications in the virtual world, object based avatar tracking controller 306 sends query 310 to object avatar-rendering table 304. In response to query 310, virtual world database 302 sends data 312 to virtual world software 308 for utilization by object based avatar tracking controller 306 to track avatars and implement modifications of the selected objects to improve the location and appearance of the selected objects within the virtual world and enable improved visibility of the selected objects. Virtual world software 308 is software for rendering the virtual world. Virtual world software 308 includes object-based avatar tracking controller 306, Object based avatar tracking controller 306 is software for tracking avatars within the viewable field of each selected object. Object avatar rendering table 304 stores a universally unique identifier (UUID) for each selected object in the virtual world. A selected object is an object in a plurality of objects in the virtual world that is tracked, monitored, managed, or associated with object avatar rendering table 304. Object avatar rendering table 304 also stores universally unique identifiers and other data describing avatars within a viewable field of a selected object or within a selected zone or range associated with the selected object. For example, if the selected objects include object A and object B, then object avatar rendering table 304 stores object A universally unique identifier, universally unique identifiers and other data for all avatars within the viewable field of object A, object B universally unique identifier, and universally unique identifiers and other data describing all avatars within the viewable field of object B. Object avatar rendering table 304 stores a universally unique identifier (UUID) for each selected object in the virtual world. A selected object is an object in a plurality of objects in the virtual world that is tracked, monitored, managed, or associated with object avatar rendering table 304. Object avatar rendering table 304 also stores universally unique identifiers and other data describing avatars within a viewable field of a selected object or within a selected zone or range associated with the selected object. For example, if the selected objects include object A and object B, then object avatar rendering table 304 stores object A universally unique identifier, universally unique identifiers and other data for all avatars within the viewable field of object A, object B universally unique identifier, and universally unique identifiers and other data describing all avatars within the viewable field of object B.

Referring now to FIG. 6B a block diagram of the data flow 400 between various hardware and software components of a client/server environment implementing a virtual world is shown according to an illustrative embodiment. Virtual World client application 410 is a software application, executing on a client data processing system. Virtual World client application 410 allows for connection to, and interaction within a virtual world. In response to an indication from a user, virtual world client application 410 sends snapshot request 412 to virtual world server 414. Snapshot request 412 is a request for a graphical rendering of the viewable field of a particular user's avatar, as displayed by virtual world client application 410. The snapshot request can be a request for a static image, or a video of the rendering of the viewable field. Virtual world server 414 is a data processing system that executes software to enable a virtual world, such as virtual world server 300. Responsive to receiving snapshot request 412, virtual world server 414 forwards scene descriptions 416 to backend rendering system 418. Scene description 416 is a non-graphical representation of the viewable field of a particular user's avatar. Scene description 416 includes virtual world location information such as an exact camera location within the virtual world, and a camera angle vector. The exact camera location within the virtual world and the camera angle vector can be expressed as coordinates in a 3D coordinate system, such as for example in an <X, Y, Z> format, Scene description 416 can also include information regarding the format and delivery of the rendered snapshot, such as for example but not limited to, an image size, a file type format, delivery options, whether to include avatars within the snapshot, and desired fidelity/resolution of the snapshot. Scene description 416 going to backend rendering system 418 are a subset of the updates going to the client. Backend rendering system 418 is a graphics-processing unit capable of generating images and video of activity within a virtual world. Backend rendering system 418 is capable of rendering images and video of higher quality than local 3D rendering hardware and software running virtual world client application 410 because backend rendering system 418 utilizes images and textures that are themselves not used to create the virtual world as rendered by virtual world client application 410. Backend rendering system 418 produces high quality images by using higher quality models, shaders, and textures, or by implementing a ray tracing system. The models, shaders, textures, and ray tracing system utilized by backend rendering system 418 are not used in rendering the virtual world as is typically rendered by virtual world client application 410. In one illustrative embodiment, backend rendering system 418 implements high quality ray tracing effects using a Cell Broadband Engine Architecture based system. In one illustrative embodiment, backend rendering system 418 implements high quality models, shaders, and textures using traditional graphical processing unit hardware. Responsive to receiving scene description 416, backend rendering system 418 sends request 420 for high fidelity objects to visual database 422. Visual database 422 contains textures, geometry, and shaders that are needed to implement the virtual world. A scene description is downloaded onto backend rendering system 418, and the needed textures, geometry, and shaders are downloaded from the Visual database. Updates are then sent to backend rendering system 418 as the avatar moves in the scene. Backend rendering system 418 adjusts and moves the rendered avatars and objects accordingly. Visual database 422 stores geometric data, textures, and effects data associated with the form or shape of avatars and objects in the virtual world. Visual database 422 can be referenced by an Object avatar-rendering table in order to obtain geometric data, textures, and effects data to render the virtual world. Visual database 422 contains lightweight graphics 424 and high fidelity graphics 426. Lightweight graphics 424 include the 3D geometry, textures, shaders that are utilized by both virtual world server 414 and virtual world client application 410 to render the virtual world to the client. Lightweight graphics 424 are delivered to the virtual world server 414 in response to a request 428 for low fidelity objects sent from virtual world server 414 to visual database 422. High fidelity graphics 426 is a high fidelity version of geometry, textures, shaders that are utilized by backend rendering system 418 to create high fidelity snapshots and videos. Due to the bandwidth and processing requirements, high fidelity graphics 426 are not utilized by virtual world client application 410 in rendering the virtual world in real time. Backend rendering system 418 utilizes high fidelity graphics 426 to create high fidelity video and images 430. In one illustrative embodiment, backend rendering system 418 implements high quality ray tracing effects using a cell based system. In one illustrative embodiment, backend rendering System 418 implements high quality models, shaders, textures using traditional graphical processing unit hardware. In one illustrative embodiment, backend rendering system 418 implements high quality ray tracing effects using the Cell Broadband Engine Architecture based system. Backend rendering system 418 ray tracing determines the visibility of surfaces within an image by tracing imaginary rays of light from viewer's eye to the object. A separate ray is utilized for each resolved point, typically for each pixel of the display. For example, for a modest image resolution of 1064×768, a ray-tracer needs to trace 1064×768, or 817,152 separate rays for each displayed image. While the ray-traced image is very realistic due to the separate casting of each resolved point, the sheer number of rays that must be traced results in longer process times that are typically unsuitable for real time processing that must occur when implementing a virtual world. In one illustrative embodiment, backend rendering system 418 implements high quality ray tracing effects using a cell based system. A cell based system is a data processing system using the Cell Broadband Engine Architecture. The Cell Broadband Engine Architecture is a multi-core processor. The cell-based, system differs from traditional multi-core processors in that the cell based system does not consist of multiple copies of the same core. Instead, the cell based system utilizes heterogeneous processors, consisting of one PowerPC core and a plurality of synergistic co-processor elements. The synergistic co-processor elements are typically smaller than traditional cores and are designed for streaming workloads. The PowerPC core performs synchronization tasks and executes non-parallizeable code. The synergistic co-processor elements perform the balance of the work in a streaming manner. In one illustrative embodiment, backend rendering system 418 creates create high fidelity video and images 430 by sending scene updates to the backend rendering system as the client moves the avatar moves in the scene and objects move or change in the scene. The backend rendering system adjusts and moves the viewing position and rendered avatars and objects accordingly. In one illustrative embodiment, ray-traced images rendered by the Cell Broadband Engine Architecture based system of backend rendering system 418 are created at fast time intervals using scene updates. To create the illusion of smoother movement between the ray-traced key frames, the key frame animation software extrapolates in-between geometry and positions from scene updates to create a smoother animation. As the client navigates the virtual world, avatar and camera movement 432 are communicated to virtual world server 414. Additional scene descriptions 434 are passed to backend rendering system 418 and stored in scene update database 436 until additional scene descriptions 434 are utilized by backend rendering system 418. Scene update database 436 is a storage that holds scene descriptions, such as additional scene descriptions 434, until those scene descriptions are utilized by backend rendering system 418 to create high fidelity video and images 430. Thus, scene update database 436 acts as a buffer system, temporarily storing additional scene descriptions 434 for the backend rendering system 418. In this manner, backend rendering system 418 is able to function in a non-real time. Backend rendering system 418 is therefore able to create realistic images and videos without sacrificing resolution so that processing can be performed in real time. Once backend rendering system 418 creates high fidelity video and images 430, high fidelity video and images 430 are stored in video database 438 until high fidelity video and images 430 is delivered to a client system.

Embodiments herein recognize that in moving between environments, be it physical or virtual worlds, can benefit from having access to certain articles and data that moves between the boundaries of these environments. For instance, being able to carry a smartphone with contact information into a virtual world or consequentially take notes in the virtual worlds and have them be accessible in the physical world. Embodiments herein recognize that a “fourth dimension” intersectional space that is permeable between multiple virtual worlds and back into the 3D physical space would be useful when pertaining to an intelligent workflow.

Embodiments herein can include recognition of articles from the physical world and tagging such articles as they are brought into the virtual space. In one example, a user can bring a notepad type device into a virtual world to be use with their avatar as a note taking device as part of the home buying and lending process. Embodiments herein can include prioritize data sets and articles for the purposes of facilitating transactions.

Embodiments herein can include tournament based generational selection of an article or articles to translate between physical and virtual environments. Embodiments herein can include nested transformer based models to measure the personalized importance of articles. Embodiments herein can include methods to identify objects and corresponding data that would benefit from being represented in a virtual world based on historical, current, and future activities. Embodiments herein can include a system and method to apply a 4D space to capture, identify permissions, and allow access to articles and data through multiple shares of environment representations. Embodiments herein can include a system and method to construct a visually accessible user interface (UI) rendering of an article and data in a virtual world (e.g., smartwatch with data into a virtual world, camera+pictures from camera).

Embodiments herein can include, based on context of activity in physical or virtual world, dynamically creating appropriate data transfer/migration rules between physical and virtual world and will be identifying if full load or incremental data load will be performed between a virtual world and a physical world and vice versa. Embodiments herein can include an extract, transform, and load (ETL) process that can use appropriate data transformation that can include various operations, e.g., Update; Insert; Append; Delete; Transform, etc. In one use case, a user can take a smartphone in a virtual world, and in the virtual world can receive some set of data which are new, some sets of data which are to be deleted, some sets of data which are to be appended etc. Based on data security parameters between physical and virtual worlds, embodiments herein can be evaluating the security need and will dynamically be creating a view of data elements with appropriate security, so, only relevant data will be shown in appropriate world (physical/metaverse). For example, some of the data collected in the virtual world is not appropriate in a physical world, so embodiments herein can be creating a view of the data in the physical world filtering the virtual world data.

Embodiments herein can leverage natural language processing (NLP) to identify what data should be gathered in the physical world and virtual world to perform a bi-directional data extract, transform and load (ETL) using a mobile UE device, e.g., a smartphone. In one example, a user can be searching for a new home and decides to visit a representation of the home in a virtual reality environment. The user can take the user's smartphone in the virtual world in order to have access to her contacts, take pictures, and write/dictate notes. The user can meet with a realtor in the virtual world and receives information about the home toured by the user. The user is able to take pictures and capture data on the user's smartphone. When leaving the virtual world, the user is able to see on the user's smartphone the pictures taken in the virtual world and notes, plus a transcript of the conversation with her realtor which occurred in the virtual world. Additionally, the user has a representation of the flyer the realtor handed the user in the virtual world manifested digitally on the user's smartphone.

In another example, a user is conducting business in a virtual world. The user is meeting with clients and making deals. This involves the exchange of information, demos, and processing. The user is able to prepare for his business meeting in the physical world and enter into the virtual world bringing his slides/apps with him to walk through a presentation with his client. The user could bring his ‘laptop’ with into the virtual world or choose to have the data be available to him and presented through his personal screen in the virtual world that contains access to all his relevant and accessible data.

Embodiments herein can include identifying data and/or articles and data associated with an article that desirable to carry between worlds. Identifying the data and/or articles that would benefit from be carried between worlds can be achieved through various approaches, depending on the specifics of the situation. Embodiments herein can benefit from an examining of existing documentation. If the data or article has been previously identified or documented, embodiments herein can examine the relevant documentation to determine what can benefit from being carried between worlds. Embodiments herein can benefit from an assessment to identify what data or articles are critical to the success of the transfer and what can be left behind. Embodiments herein can include examining risks associated with leaving behind any data or objects to determine what must be carried between worlds. Embodiments herein can include examining processes involved in the transfer of the data or article and determining what data or article can benefit from being carried between worlds to facilitate those processes.

Embodiments herein can include providing a system so that data created in the virtual world can be accessed in the physical world and vice versa. For providing such functionality, Cloud-based storage and synchronization can be utilized. One approach is to use a cloud-based storage service to store the data and enable synchronization between the virtual and physical worlds. For example, if a user creates a 3D model in a virtual reality environment, the model can be automatically saved to the cloud and accessed later from a physical device or vice versa. Such functionality can benefit from cloud storage APIs and possibly custom code to handle the synchronization.

In one aspect, embodiments herein can benefit from use of QR codes or other physical identifiers. Embodiments herein can use physical identifiers such as QR codes or NFC tags to link the virtual and physical worlds. In one use case, a user can scan a QR code with a mobile device in the physical world to access a corresponding virtual object, or vice versa. The described functionality can benefit from developing a system to generate and manage the physical identifiers, as well as software to handle the linking and data transfer.

Embodiments herein can employ Bluetooth or other wireless protocols. Embodiments herein can use wireless protocols such as Bluetooth or Wi-Fi to enable data transfer between the virtual and physical worlds. In one example, a user can wear a smartwatch in the physical world that communicates with a virtual reality headset to provide real-time data on the user's physical activity. The described functionality can benefit from developing software to handle the wireless communication and data transfer, as well as possibly custom hardware integration.

Embodiments herein can identify data that would be appropriate to use between worlds based on user's usage patterns, where they visit, what they do, who they connect with. Embodiments herein can employ a combination of clustering and association rule mining techniques on the user's behavior data.

In a data collection stage, there can be performed collecting data on user behavior in both the virtual and physical worlds, including location data, social network data, browsing history, and any other relevant data. In a data preprocessing stage, there can be performed preprocessing the data to remove any irrelevant or redundant features and convert the data into a format suitable for machine learning algorithms. In a clustering stage, there can be performed clustering the data using an unsupervised learning algorithm such as K-means or DBSCAN. Clustering can group together similar behavior patterns across both the virtual and physical worlds. In an association rule mining stage, there can be performed use association rule mining techniques such as Apriori or FP-growth to identify frequent article sets and association rules within each cluster. This will help to identify patterns in the user's behavior, such as frequent locations or connections between virtual and physical world activities. In a data selection stage, there can be performed based on the identified patterns, selecting the data that would be appropriate to use between the virtual and physical worlds. For example, if a user frequently visits a certain location in the physical world and interacts with certain individuals in the virtual world, this data could be selected for use between the two worlds. In a model training stage, there can be performed training a gradient boosting classifier machine learning model to predict which data should be used between the virtual and physical worlds based on the identified patterns. In a deployment stage, there can be performed deploying the model in the system to identify appropriate data to use between the virtual and physical worlds based on the user's behavior patterns. There can be performed in a continuous learning stage continuously updating the model as new data becomes available to improve the accuracy of the predictions and adapt to changes in the user's behavior over time. The described machine learning algorithm can help in identifying appropriate data to use between the virtual and physical worlds based on the user's behavior patterns, making it more efficient and effective.

In further aspects, articles to be represented in physical and virtual worlds can be identified through a tagging system by the user or can be suggested by the system as candidates for interoperability consideration (e.g., wearable is candidate for based on usage patterns).

In a user-generated tagging system, the user can tag objects that they want to represent in both physical and virtual worlds. For example, if the user wants to represent their watch in the virtual world, they can tag it as a wearable that they want to connect to their virtual avatar. In one embodiment, manager system 110 can suggest objects that are candidates for interoperability consideration based on the user's usage patterns. For example, if the system detects that the user frequently uses a fitness tracker, it can suggest that the fitness tracker can be a candidate for representation in the virtual world. In both cases, the tags can be used to identify objects that can be represented in both physical and virtual worlds. The tags can be stored in data repository 108 along with other metadata, such as the article's type, brand, and model. This information can be used by the system to map the article to its digital counterpart and to train the machine learning model in the described machine learning stage to identify patterns and usage behaviors associated with the object. In one embodiment, a user can specify type of data accessed and permissions granted for both physical and virtual world settings (e.g., text created, photos, verbal capture). In such an embodiment, manager system 110 can provide users with a user interface that allows them to specify the types of data they want to share between the physical and virtual worlds, as well as the permissions granted for each type of data. For example, the user interface can have options for text, photos, and verbal capture, among other types of data. Users can select which types of data they want to share, and for each type of data, they can specify the level of permissions granted. For example, users can choose to share photos only with their close friends and family members, while allowing everyone to access their text messages. The user interface can also provide users with an option to review and update their settings, as well as to revoke permissions granted for certain types of data. This will enable users to manage their privacy and ensure that their data is being used only as intended. Manager system 110 can provide a user-friendly interface that allows users to specify the types of data they want to share, and the permissions granted for each type of data, giving them greater control over their data and privacy. Specified objects can be mirrored in physical and virtual worlds. Mirroring of functionality can be achieved through various methods depending on the type of object being mirrored. For example, in the case of a mobile UE device, the physical device can be connected to a virtual environment via a wireless or wired connection. The virtual environment can then mirror the device's screen and functionality, allowing the user to interact with it as if it were physically present. In the case of wearables, the physical device can be synchronized with a virtual environment, allowing the user to track their fitness progress or other metrics in both the physical and virtual worlds. Other types of objects, such as IoT devices including smart home appliances or smart equipment, can also be mirrored in both physical and virtual worlds using appropriate connectivity protocols and APIs. Features can be provided to ensure that the objects are seamlessly integrated and function in both worlds without any disruptions or issues.

Various available tools, libraries, and/or services can be utilized for implementation of predictive model 4102 and/or predictive model 4202. For example, a machine learning service can provide access to libraries and executable code for support of machine learning functions. A machine learning service can provide access set of REST APIs that can be called from any programming language and that permit the integration of predictive analytics into any application. Enabled REST APIs can provide, e.g., retrieval of metadata for a given predictive model, deployment of models and management of deployed models, online deployment, scoring, batch deployment, stream deployment, monitoring and retraining deployed models. A machine learning service can provide access set of REST APIs that can be called from any programming language and that permit the integration of predictive analytics into any application. Enabled REST APIs can provide, e.g., retrieval of metadata for a given predictive model, deployment of models and management of deployed models, online deployment, scoring, batch deployment, stream deployment, monitoring and retraining deployed models. Predictive model 4102 and/or predictive model 4202 can include use of, e.g., support vector machines (SVM), Bayesian networks, neural networks and/or other machine learning technologies.

Embodiments herein can include a method and system comprising: analyzing physical and virtual world activity using natural language processing (NLP) to identify what data and/or objects should be gathered in the physical world and virtual world to perform a bi-directional data extract, transform and load (ETL) using a mobile device for facilitating transactions, automating tasks, and improving collaboration between users; using a tournament based generational selection algorithm for selecting a group of data and/or objects of the gathered data and/or objects for translation between physical and virtual environments; and identifying data and/or objects that would be appropriate to use between worlds based on user's usage patterns, where they visit, what they do, who they connect with using a combination of clustering and association rule mining techniques on the user's behavior data.

Certain embodiments herein may offer various technical computing advantages involving computing advantages to address problems arising in the realm of computer systems and networks. Embodiments herein, for example, improve computer technology in the area of provisioning of electronic devices defining physical articles. In embodiments herein, electronic devices defining physical articles can be provisioned to emulate the behavior of virtual world article counterparts, thus, enhancing user experience of users associated to such articles both in a physical world operating environment and in a virtual world operating environment. Embodiments herein improve computer technology also in the realm of virtual reality environments by provisioning virtual world features to provision virtual articles to emulate functional behavior of counterpart articles associated to users in the physical world. In such manner, embodiments herein improve user interface functionality of computers by enhancement of engagement of a computer with the user. Embodiments herein can track article usage of a user in a physical world environment and based on such tracking can generate prompting data that prompts a user to provision a counterpart and based on such tracking can generate prompting data that prompts a user to provision a virtual world counterpart of the physical world article. Embodiments herein can include tracking of usage and behavior of a virtual world article of a user encountered in a virtual world environment, and based on such tracking and examining, can generate prompting data that prompts a user to provision a physical world counterpart to the virtual world article. Embodiments herein can include use of predictive models that predict behavior of a user with respect to provisioning of articles, including virtual world electronic devices and physical world electronic devices. Training data for training a predictive model can be accumulated as a result, where a user using an article in the physical world and in other use cases can include data respecting usage of an article by a user in a virtual environment. Various decision data structures can be used to drive artificial intelligence (AI) decision making, such as decision data structure that cognitively maps social media interactions in relation to posted content in respect to parameters for use in better allocations that can include allocations of digital rights. Decision data structures as set forth herein can be updated by machine learning so that accuracy and reliability is iteratively improved over time without resource consuming rules intensive processing. Machine learning processes can be performed for increased accuracy and for reduction of reliance on rules based criteria and thus reduced computational overhead. For enhancement of computational accuracies, embodiments can feature computational platforms existing only in the realm of computer networks such as artificial intelligence platforms, and machine learning platforms. Embodiments herein can employ data structuring processes, e.g., processing for transforming unstructured data into a form optimized for computerized processing. Embodiments herein can examine data from diverse data sources such as data sources that process radio signals for location determination of users. Embodiments herein can include artificial intelligence processing platforms featuring improved processes to transform unstructured data into structured form permitting computer based analytics and decision making. Embodiments herein can include particular arrangements for both collecting rich data into a data repository and additional particular arrangements for updating such data and for use of that data to drive artificial intelligence decision making. Certain embodiments may be implemented by use of a cloud platform/data center in various types including a Software-as-a-Service (SaaS), Platform-as-a-Service (PaaS), Database-as-a-Service (DBaaS), and combinations thereof based on types of subscription.

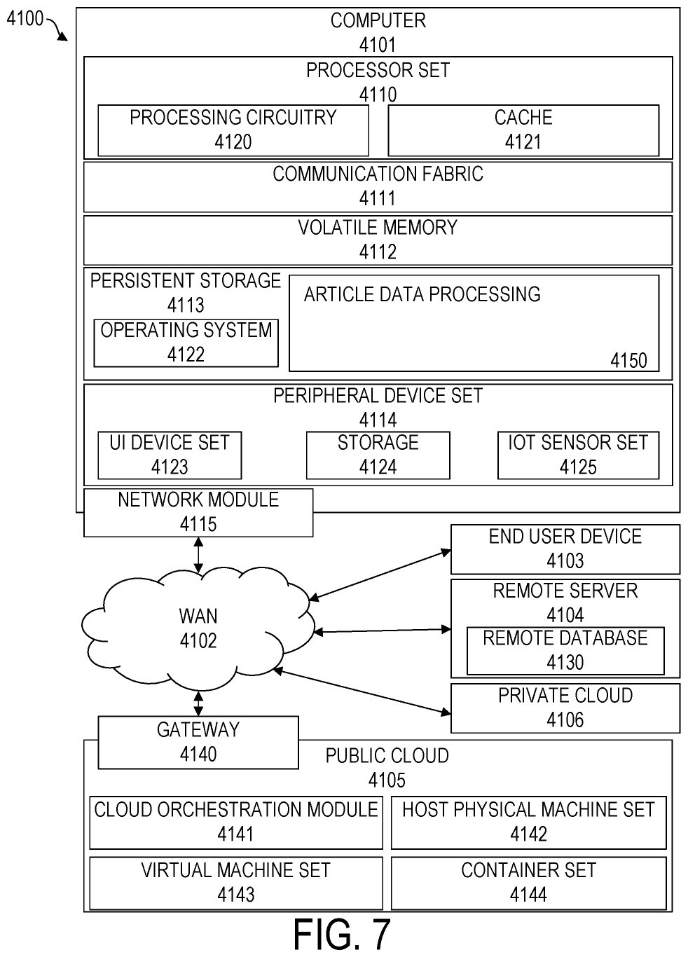

In reference to FIG. 7, there is set forth a description of a computing environment 4100 that can include one or more computer 4101. In one example, a computing node as set forth herein can be provided in accordance with computer 4101 as set forth in FIG. 7.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Hash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

One example of a computing environment to perform, incorporate and/or use one or more aspects of the present invention is described with reference to FIG. 7. In one aspect, a computing environment 4100 contains an example of an environment for the execution of at least some of the computer code involved in performing the inventive methods, such as code 4150 for performing article data processing described with reference to FIGS. 1-6B. In addition to block 4150, computing environment 4100 includes, for example, computer 4101, wide area network (WAN) 4102, end user device (EUD) 4103, remote server 4104, public cloud 4105, and private cloud 4106. In this embodiment, computer 4101 includes processor set 4110 (including processing circuitry 4120 and cache 4121), communication fabric 4111, volatile memory 4112, persistent storage 4113 (including operating system 4122 and block 4150, as identified above), peripheral device set 4114 (including user interface (UI) device set 4123, storage 4124, and Internet of Things (IoT) sensor set 4125), and network module 4115. Remote server 4104 includes remote database 4130. Public cloud 4105 includes gateway 4140, cloud orchestration module 4141, host physical machine set 4142, virtual machine set 4143, and container set 4144. IoT sensor set 4125, in one example, can include a Global Positioning Sensor (GPS) device, one or more of a camera, a gyroscope, a temperature sensor, a motion sensor, a humidity sensor, a pulse sensor, a blood pressure (bp) sensor or an audio input device.

Computer 4101 may take the form of a desktop computer, laptop computer, tablet computer, smartphone, smart watch or other wearable computer, mainframe computer, quantum computer or any other form of computer or mobile device now known or to be developed in the future that is capable of running a program, accessing a network or querying a database, such as remote database 4130. As is well understood in the art of computer technology, and depending upon the technology, performance of a computer-implemented method may be distributed among multiple computers and/or between multiple locations. On the other hand, in this presentation of computing environment 4100, detailed discussion is focused on a single computer, specifically computer 4101, to keep the presentation as simple as possible. Computer 4101 may be located in a cloud, even though it is not shown in a cloud in FIG. 7. On the other hand, computer 4101 is not required to be in a cloud except to any extent as may be affirmatively indicated.

Processor set 4110 includes one, or more, computer processors of any type now known or to be developed in the future. Processing circuitry 4120 may be distributed over multiple packages, for example, multiple, coordinated integrated circuit chips. Processing circuitry 4120 may implement multiple processor threads and/or multiple processor cores. Cache 4121 is memory that is located in the processor chip package(s) and is typically used for data or code that should be available for rapid access by the threads or cores running on processor set 4110. Cache memories are typically organized into multiple levels depending upon relative proximity to the processing circuitry. Alternatively, some, or all, of the cache for the processor set may be located “off chip.” In some computing environments, processor set 4110 may be designed for working with qubits and performing quantum computing.

Computer readable program instructions are typically loaded onto computer 4101 to cause a series of operational steps to be performed by processor set 4110 of computer 4101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 4121 and the other storage media discussed below. The program instructions, and associated data, are accessed by processor set 4110 to control and direct performance of the inventive methods. In computing environment 4100, at least some of the instructions for performing the inventive methods may be stored in block 4150 in persistent storage 4113.

Communication fabric 4111 is the signal conduction paths that allow the various components of computer 4101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 4112 is any type of volatile memory now known or to be developed in the future. Examples include dynamic type random access memory (RAM) or static type RAM. Typically, the volatile memory is characterized by random access, but this is not required unless affirmatively indicated. In computer 4101, the volatile memory 4112 is located in a single package and is internal to computer 4101, but, alternatively or additionally, the volatile memory may be distributed over multiple packages and/or located externally with respect to computer 4101.

Persistent storage 4113 is any form of non-volatile storage for computers that is now known or to be developed in the future. The non-volatility of this storage means that the stored data is maintained regardless of whether power is being supplied to computer 4101 and/or directly to persistent storage 4113. Persistent storage 4113 may be a read only memory (ROM), but typically at least a portion of the persistent storage allows writing of data, deletion of data and re-writing of data. Some familiar forms of persistent storage include magnetic disks and solid state storage devices. Operating system 4122 may take several forms, such as various known proprietary operating systems or open source. Portable Operating System Interface-type operating systems that employ a kernel. The code included in block 4150 typically includes at least some of the computer code involved in performing the inventive methods.

Peripheral device set 4114 includes the set of peripheral devices of computer 4101. Data communication connections between the peripheral devices and the other components of computer 4101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 4123 may include components such as a display screen, speaker, microphone, wearable devices (such as goggles and smart watches), keyboard, mouse, printer, touchpad, game controllers, and haptic devices. Storage 4124 is external storage, such as an external hard drive, or insertable storage, such as an SD card. Storage 4124 may be persistent and/or volatile. In some embodiments, storage 4124 may take the form of a quantum computing storage device for storing data in the form of qubits. In embodiments where computer 4101 is required to have a large amount of storage (for example, where computer 4101 locally stores and manages a large database) then this storage may be provided by peripheral storage devices designed for storing very large amounts of data, such as a storage area network (SAN) that is shared by multiple, geographically distributed computers. IoT sensor set 4125 is made up of sensors that can be used in Internet of Things applications. For example, one sensor may be a thermometer and another sensor may be a motion detector. A sensor of IoT sensor set 4125 can alternatively or in addition include, e.g., one or more of a camera, a gyroscope, a humidity sensor, a pulse sensor, a blood pressure (bp) sensor or an audio input device.

Network module 4115 is the collection of computer software, hardware, and firmware that allows computer 4101 to communicate with other computers through WAN 4102. Network module 4115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 4115 are performed on the same physical hardware device. In other embodiments (for example, embodiments that utilize software-defined networking (SDN)), the control functions and the forwarding functions of network module 4115 are performed on physically separate devices, such that the control functions manage several different network hardware devices. Computer readable program instructions for performing the inventive methods can typically be downloaded to computer 4101 from an external computer or external storage device through a network adapter card or network interface included in network module 4115.

WAN 4102 is any wide area network (for example, the internet) capable of communicating computer data over non-local distances by any technology for communicating computer data, now known or to be developed in the future. In some embodiments, the WAN 4102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 4103 is any computer system that is used and controlled by an end user (for example, a customer of an enterprise that operates computer 4101), and may take any of the forms discussed above in connection with computer 4101. EUD 4103 typically receives helpful and useful data from the operations of computer 4101. For example, in a hypothetical case where computer 4101 is designed to provide a recommendation to an end user, this recommendation would typically be communicated from network module 4115 of computer 4101 through WAN 4102 to EUD 4103. In this way, EUD 4103 can display, or otherwise present, the recommendation to an end user. In some embodiments, EUD 4103 may be a client device, such as thin client, heavy client, mainframe computer, desktop computer and so on.

Remote server 4104 is any computer system that serves at least some data and/or functionality to computer 4101. Remote server 4104 may be controlled and used by the same entity that operates computer 4101. Remote server 4104 represents the machine(s) that collect and store helpful and useful data for use by other computers, such as computer 4101. For example, in a hypothetical case where computer 4101 is designed and programmed to provide a recommendation based on historical data, then this historical data may be provided to computer 4101 from remote database 4130 of remote server 4104.

Public cloud 4105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 4105 is performed by the computer hardware and/or software of cloud orchestration module 4141. The computing resources provided by public cloud 4105 are typically implemented by virtual computing environments that run on various computers making up the computers of host physical machine set 4142, which is the universe of physical computers in and/or available to public cloud 4105. The virtual computing environments (VCEs) typically take the form of virtual machines from virtual machine set 4143 and/or containers from container set 4144. It is understood that these VCEs may be stored as images and may be transferred among and between the various physical machine hosts, either as images or after instantiation of the VCE. Cloud orchestration module 4141 manages the transfer and storage of images, deploys new instantiations of VCEs and manages active instantiations of VCE deployments. Gateway 4140 is the collection of computer software, hardware, and firmware that allows public cloud 4105 to communicate through WAN 4102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 4106 is similar to public cloud 4105, except that the computing resources are only available for use by a single enterprise. While private cloud 4106 is depicted as being in communication with WAN 4102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 4105 and private cloud 4106 are both part of a larger hybrid cloud.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figs. illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figs. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. As a result, a method or device that “comprises,” “has,” “includes,” or “contains” one or more steps or elements possesses those one or more steps or elements, but is not limited to possessing only those one or more steps or elements. Likewise, a step of a method or an element of a device that “comprises,” “has,” “includes,” or “contains” one or more features possesses those one or more features, but is not limited to possessing only those one or more features. Forms of the term “based on” herein encompass relationships where an element is partially based on as well as relationships where an element is entirely based on. Methods, products and systems described as having a certain number of elements can be practiced with less than or greater than the certain number of elements. Furthermore, a device or structure that is configured in a certain way is configured in at least that way, but may also be configured in ways that are not listed.

It is contemplated that numerical values, as well as other values that are recited herein are modified by the term “about”, whether expressly stated or inherently derived by the discussion of the present disclosure. As used herein, the term “about” defines the numerical boundaries of the modified values so as to include, but not be limited to, tolerances and values up to, and including the numerical value so modified. That is, numerical values can include the actual value that is expressly stated, as well as other values that are, or can be, the decimal, fractional, or other multiple of the actual value indicated, and/or described in the disclosure.

The corresponding structures, materials, acts, and equivalents of all means or step plus function elements in the claims below, if any, are intended to include any structure, material, or act for performing the function in combination with other claimed elements as specifically claimed. The description set forth herein has been presented for purposes of illustration and description, but is not intended to be exhaustive or limited to the form disclosed. Many modifications and variations will be apparent to those of ordinary skill in the art without departing from the scope and spirit of the disclosure. The embodiment was chosen and described in order to best explain the principles of one or more aspects set forth herein and the practical application, and to enable others of ordinary skill in the art to understand one or more aspects as described herein for various embodiments with various modifications as are suited to the particular use contemplated.

What is claimed is:

1. A computer implemented method comprising:
with a user engaged in a user session within a first environment, examining historical data of the user, wherein the examining historical data of the user includes examining historical data of a previously recognized article of the user previously recognized in a second environment; and
provisioning an article of the user within the first environment to include a functional behavior, wherein the article of the user within the first environment includes an article type classification in common with the previously recognized article, and wherein the provisioning the article to include the functional behavior is performed in dependence on a result of the examining the historical data of the user.

2. The computer implemented method of claim 1, wherein the examining the historical data of the user is performed responsively to a detection of the article of the user in the first environment.

3. The computer implemented method of claim 1, wherein the provisioning the article to include the functional behavior is performed in dependence on a result of examining historical data of the previously recognized article of the user previously recognized in the second environment.

4. The computer implemented method of claim 1, wherein the historical data of the user includes historical data of the article of the user within the first environment, wherein the provisioning the article to include the functional behavior is performed in dependence on a result of examining the historical data of the article of the user within the first environment.

5. The computer implemented method of claim 1, wherein the provisioning the article to include the functional behavior is performed in dependence on a result of examining historical data of the previously recognized article of the user previously recognized in the second environment, wherein the historical data of the user includes historical data of the article of the user within the first environment, wherein the provisioning the article to include the functional behavior is performed in dependence on a result of examining the historical data of the article of the user within the first environment.

6. The computer implemented method of claim 1, wherein the examining historical data of the previously recognized article of the user previously recognized in a second environment is performed responsively to a determination that the article of the user will be added to the first environment.

7. The computer implemented method of claim 1, further comprising generating prompting data in dependence on the examining historical data of the previously recognized article of the user previously recognized in a second environment, wherein the prompting data prompts the user to activate the provisioning.

8. The computer implemented method of claim 1, further comprising generating prompting data in dependence on the examining historical data of the previously recognized article of the user previously recognized in a second environment, wherein the prompting data prompts the user to activate the provisioning, wherein the prompting data specifies a first candidate functional behavior for selection by the user, wherein the prompting data specifies a second candidate functional behavior for selection by the user.

9. The computer implemented method of claim 1, further comprising generating prompting data in dependence on the examining historical data of the previously recognized article of the user previously recognized in a second environment, wherein the prompting data prompts the user to activate the provisioning, wherein the prompting data specifies a first candidate functional behavior for selection by the user, wherein the prompting data specifies a second candidate functional behavior for selection by the user, wherein the provisioning is activated in response to the user selecting one of the first candidate functional behavior or the second candidate functional behavior specified by the prompting data.

10. The computer implemented method of claim 1, further comprising generating prompting data in dependence on the examining historical data of the previously recognized article of the user previously recognized in the second environment, wherein the examining historical data of the previously recognized article of the user previously recognized in a second environment includes identifying a first candidate functional behavior of the article, and identifying a second candidate functional behavior of the article, wherein the method includes evaluating security risk associated to the first candidate functional behavior of the article, and evaluating security risk associated to the second candidate functional behavior of the article, wherein the method includes generating prompting data in dependence on the examining historical data of the previously recognized article of the user previously recognized in a second environment, wherein the prompting data specifies the first candidate functional behavior and the second candidate functional behavior.

11. The computer implemented method of claim 1, further comprising generating prompting data in dependence on the examining historical data of the previously recognized article of the user previously recognized in the second environment, wherein the examining historical data of the previously recognized article of the user previously recognized in a second environment includes identifying a first candidate functional behavior of the article, and identifying a second candidate functional behavior of the article, wherein the method includes evaluating security risk associated to the first candidate functional behavior of the article, and evaluating security risk associated to the second candidate functional behavior of the article, wherein the method includes generating prompting data in dependence on the examining historical data of the previously recognized article of the user previously recognized in a second environment, wherein the prompting data specifies the first candidate functional behavior and the second candidate functional behavior, wherein the prompting data includes an indicator of a determined security risk of the first candidate functional behavior, and wherein the prompting data includes an indicator of a determined security risk of the second candidate functional behavior.

12. The computer implemented method of claim 1, wherein the first environment is a virtual environment, and wherein the second environment is a physical environment, wherein the method includes generating prompting data in dependence on the examining historical data of the previously recognized article of the user previously recognized in the second environment, wherein the method includes identifying a first candidate functional behavior of the article, and identifying a second candidate functional behavior of the article of the user in the first environment, wherein the method includes evaluating security risk associated to the first candidate functional behavior of the article of the user in the first environment, the evaluating security risk associated to the first candidate functional behavior of the article including evaluating use of a counterpart physical article of the article in the physical environment, and evaluating security risk associated to the second candidate functional behavior of the article, wherein the method includes generating prompting data in dependence on the examining historical data of the previously recognized article of the user previously recognized in a second environment, wherein the prompting data specifies the first candidate functional behavior and the second candidate functional behavior, wherein the prompting data includes an indicator of a determined security risk of the first candidate functional behavior, and wherein the prompting data includes an indicator of a determined security risk of the second candidate functional behavior, and wherein the prompting data indicates differentiated security risk associated to the first candidate functional behavior and the second candidate functional behavior, respectively.

13. The computer implemented method of claim 1, wherein the first environment is a virtual environment, and wherein the second environment is a physical environment.

14. The computer implemented method of claim 1, wherein the first environment is a physical environment, and wherein the second environment is a virtual environment.

15. The computer implemented method of claim 1, wherein the provisioning the article to include the functional behavior is performed in dependence on a result of examining historical data of the article of the user within the first environment, wherein the examining historical data of the article of the user within the first environment includes querying a predictive model that has been trained with machine learning training data of historical sessions of the user in the first environment.

16. The computer implemented method of claim 1, wherein the provisioning the article to include the functional behavior is performed in dependence on a result of examining historical data of the article of the user within the first environment, wherein the examining historical data of the article of the user within the first environment includes querying a predictive model that has been trained with machine learning training data of historical sessions of the user in the first environment, wherein the machine learning training data of historical sessions of the user in the first environment includes data of historical sessions of a crowdsourced collection of users other than the user.

17. The computer implemented method of claim 1, wherein the examining historical data of the user includes examining data that specifies that the user has provisioned the recognized article of the second environment to include functional behavioral of the article of the user in the first environment.

18. The computer implemented method of claim 1, wherein the provisioning the article to include the functional behavior is performed in dependence on a result of examining historical data of the previously recognized article of the user previously recognized in the second environment, wherein the historical data of the user includes historical data of the article of the user within the first environment, wherein the provisioning the article to include the functional behavior is performed in dependence on a result of examining the historical data of the article of the user within the first environment, examining historical data of the previously recognized article of the user previously recognized in the second environment includes examining data on bytes of provisioning data used for provisioning the previously recognized article of the user in sessions of the second environment, examining a recency with which the previously recognized article of the user was recognized, examining a frequency with which the previously recognized article of the user was recognized in sessions of the second environment, wherein the examining historical data of the article of the user within the first environment includes querying a predictive model that has been trained with machine learning training data of historical sessions in the first environment, wherein the machine learning training data of historical sessions of the user in the first environment includes data of historical sessions of a crowdsourced collection of users other than the user, wherein the method includes identifying a first candidate functional behavior of the article, and identifying a second candidate functional behavior of the article of the user in the first environment, wherein the method includes evaluating security risk associated to the first candidate functional behavior of the article of the user in the first environment, the evaluating security risk associated to the first candidate functional behavior of the article including evaluating use of a counterpart physical article of the article in the physical environment, and evaluating security risk associated to the second candidate functional behavior of the article, wherein the method includes generating prompting data in dependence on the examining historical data of the previously recognized article of the user previously recognized in a second environment, wherein the prompting data specifies the first candidate functional behavior and the second candidate functional behavior, wherein the prompting data includes an indicator of a determined security risk of the first candidate functional behavior, and wherein the prompting data includes an indicator of a determined security risk of the second candidate functional behavior, and wherein the prompting data indicates differentiated security risk associated to the first candidate functional behavior and the second candidate functional behavior, respectively, wherein the provisioning is activated in response to the user selecting one of the first candidate functional behavior or the second candidate functional behavior specified by the prompting data, and wherein the method includes responsively to the user selecting the one of the first candidate functional behavior or the second candidate functional behavior specified by the prompting data, recording provisioning data of the provisioning, wherein the provisioning data of the provisioning includes an other users classifier, an environment classifier and a data action classifier specifying a provisioned functional behavior selected by the selecting, wherein the method includes further training the predictive model using the other users classifier, the environment classifier and a data action classifier specifying the provisioned functional behavior, detecting a virtual article in virtual reality session of a second user, and, in response to the detecting the virtual article presenting subsequent prompting data to the second user, wherein the subsequent prompting data is generated in dependence on a subsequent query of the predictive model as further trained in dependence on the further training using the other users classifier, the environment classifier and the data action classifier specifying the provisioned functional behavior.

19. A system comprising:
a memory;
at least one processor in communication with the memory; and
program instructions executable by one or more processor via the memory to perform a method comprising:
with a user engaged in a user session within a first environment, examining historical data of the user, wherein the examining historical data of the user includes examining historical data of a previously recognized article of the user previously recognized in a second environment; and
provisioning an article of the user within the first environment to include a functional behavior, wherein the article of the user within the first environment includes an article type classification in common with the previously recognized article, and
wherein the provisioning the article to include the functional behavior is performed in dependence on a result of the examining the historical data of the user.

20. A computer program product comprising:
a computer readable storage medium readable by one or more processing circuit and storing instructions for execution by one or more processor for performing a method comprising:
with a user engaged in a user session within a first environment, examining historical data of the user, wherein the examining historical data of the user includes examining historical data of a previously recognized article of the user previously recognized in a second environment; and
provisioning an article of the user within the first environment to include a functional behavior, wherein the article of the user within the first environment includes an article type classification in common with the previously recognized article, and wherein the provisioning the article to include the functional behavior is performed in dependence on a result of the examining the historical data of the user.
